(19) United States
(12) Patent Application Publication
(10) Pub. No.: US 2014/0219483 A1
(43) Pub. Date: Aug. 7, 2014

(54) SYSTEM AND METHOD FOR SETTING AUDIO OUTPUT CHANNELS OF SPEAKERS

(71) Applicant: SAMSUNG ELECTRONICS CO., LTD., Suwon-si (KR)

(72) Inventor: Seung-se HONG, Yongin-si (KR)

(73) Assignee: SAMSUNG ELECTRONICS CO., LTD., Suwon-si (KR)

(21) Appl. No.: 14/156,689

(22) Filed: Jan. 16, 2014

(30) Foreign Application Priority Data
Feb. 1, 2013 (KR) 10-2013-0011975

(51) Int. Cl. H04R 5/02

(52) U.S. Cl. CPC H04R 5/02
USPC 381/307

(57) ABSTRACT

A location detecting apparatus for detecting a location of a speaker includes a communication unit which communicates with a plurality of speakers, a plurality of sensors which sense optical signals respectively output from the plurality of speakers; and a controller which determines locations of the plurality of speakers according to a result of the sensing by the plurality of sensors and control the communication unit to transmit the determined location information of the plurality of speakers to an external apparatus, wherein the external apparatus sets audio output channels corresponding to the plurality of speakers based on the determined location information of the plurality of speakers.

### CROSS-REFERENCE TO RELATED APPLICATION

This application claims priority from Korean Patent Application No. 10-2013-0011975, filed on Feb. 1, 2013, in the Korean Intellectual Property Office, the disclosure of which is incorporated herein by reference in its entirety.

### BACKGROUND

1. Field

Methods and apparatuses consistent with exemplary embodiments relate to a system and a method for setting audio output channels of speakers, and more particularly, to a system which includes an electronic apparatus and a location detecting apparatus and may set audio output channels of speakers and a method thereof.

2. Description of the Related Art

It is common that an audio apparatus equipped with multi-channel speakers such as a home theater outputs audio signals which are input through an external input apparatus such as a digital versatile disk (DVD) player through the multi-channel speakers. For example, in order to reproduce 5.1 channel audio signals completely, multiple speakers including, for example, a center speaker, left and right front speakers, left and right rear speakers, and a woofer should be provided. Locations of such multiple speakers are determined according to characteristics of output channels, and amplifier output terminals to output audio signals are set to correspond to the respective speakers on the determined locations.

However, when a user is not accustomed to determining a location of each speaker according to characteristics of such output channels or connecting each speaker to an amplifier output terminal manually, audio signals input from an external source may not be correctly output through the multiple speakers.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an apparatus and a method for setting audio output channels of multiple speakers according to locations of the multiple speakers.

According to an aspect of an exemplary embodiment, there is provided a location detecting apparatus for detecting a location of a speaker, the location detecting apparatus including: a communication unit configured to communicate with a plurality of speakers; a plurality of sensors configured to sense optical signals respectively output from the plurality of speakers; and a controller configured to determine locations of the plurality of speakers according to a result of the sensing by the plurality of sensors and control the communication unit to transmit the determined location information of the plurality of speakers to an external apparatus, wherein the external apparatus sets audio output channels corresponding to the plurality of speakers based on the determined location information of the plurality of speakers.

The plurality of sensors may include: a first sensor which is placed in a center direction of the location detecting apparatus; second and third sensors which are placed in left and right front directions of the location detecting apparatus, respectively; and fourth and fifth sensors which are placed in left and right rear directions of the location detecting apparatus, respectively.

The location detecting apparatus may further include: a partition which provided between the first to fifth sensors such that the first to fifth sensors sense the optical signals output from the plurality of speakers in corresponding directions thereof; and a display configured to indicate when the first sensor is a center direction of the location detecting apparatus.

When an optical signal is sensed by at least two of the plurality of sensors within a predetermined threshold time, the controller may compare magnitudes of the optical signals sensed by the at least two of the plurality of sensors and may determine a location of a speaker which outputs the optical signal based on a location of the sensor which senses the greatest magnitude of the optical signal.

The optical signal may be an infrared rays (IR) signal.

According to an aspect of another exemplary embodiment, there is provided an electronic apparatus including: a communication unit configured to communicate with a location detecting apparatus for detecting location information of a speaker; and an audio receiver configured to receive audio signals; an audio processor configured to process the input audio signals; and a controller configured to determine audio output channels corresponding to a plurality of speakers based on location information of the plurality of speakers which is received from the location detecting apparatus through the communication unit, control the audio processor to process the input audio signals into audio signals corresponding to the determined audio output channels, and control the communication unit to transmit the processed audio signals to the plurality of speakers.

The controller may determine a number of regions defined by the location detecting apparatus in which the plurality of speakers are placed based on the location information of the plurality of speakers, and may determine the audio output channels of the plurality of speakers further based on the determined number of regions.

When channels of the input audio signals are 5.1 channels and the number of regions in which the plurality of speakers are placed is five, the controller may determine the audio output channels of the plurality of speakers as 5.1 channels.

When a number of the determined audio output channels is less than a number of the channels of the input audio signals, the controller may control the audio processor to down-mix the input audio signals based on the determined audio output channels.

The electronic apparatus may further include an input unit which receive a user command, and, when the user command is input, the controller may transmit a control signal to output an optical signal to the plurality of speakers, wherein the location detecting apparatus detects the location information of the plurality of speakers using the optical signal output from the plurality of speakers.

According to an aspect of still another exemplary embodiment, there is provided a speaker output channel setting system including: a plurality of speakers configured to output optical signals; a location detecting apparatus configured to detect optical signals by using a plurality of sensors which are placed in different directions and detect location information of the plurality of speakers based on sensing by the plurality of sensors; and an electronic apparatus configured to determine audio output channels of the plurality of speakers based on the location information of the plurality of speakers detected by the location detecting apparatus, process audio signals input from an external source into audio signals corresponding to the determined audio output channels, and transmit the processed audio signals to the plurality of speakers.

The electronic apparatus may transmit, in response to a user command, a control signal to output an optical signal to the plurality of speakers.

The electronic apparatus may determine a number of regions defined by the location detecting apparatus in which the plurality of speakers are placed based on the location information of the plurality of speakers detected by the location detecting apparatus, and may determine the audio output channels of the plurality of speakers further based on the determined number of regions.

When a number of the determined audio output channels is less than a number of channels of the audio signals input from the external source, the electronic apparatus may down-mix the input audio signals based on the determined audio output channels.

The location detecting apparatus may further include a microphone which receive an audio test signal output through the plurality of speakers, and, when the audio test signal is input from the plurality of speakers through the microphone, the location detecting apparatus may transmit response information to the electronic apparatus. The electronic apparatus may transmit a control signal to output the audio test signal to the plurality of speakers according to a user command, may obtain distance information of the plurality of speakers based on time information on a time interval from when the control signal is transmitted to the plurality of speakers to when the response information is received from the location detecting apparatus, and may control a timing of transmitting audio signals to the plurality of speakers based on the obtained distance information.

According to an aspect of another exemplary embodiment, there is provided a method for detecting a location of a speaker in a location detecting apparatus, the method including: sensing, by a plurality of sensors, optical signals respectively output from a plurality of speakers; determining locations of the plurality of speakers based on the optical signals sensed by the plurality of sensors; and transmitting the location information of the plurality of speakers to an external apparatus, wherein the external apparatus sets audio output channels corresponding to the plurality of speakers based on the determined location information of the plurality of speakers.

The plurality of sensors may include: a first sensor which is placed in a center direction of the location detecting apparatus; second and third sensors which are placed in left and right front directions of the location detecting apparatus, respectively; and fourth and fifth sensors which are placed in left and right rear directions of the location detecting apparatus, respectively.

The method may further include providing a partition between the plurality of sensors; and sensing the optical signals respectively output from the plurality of speakers in corresponding directions of the plurality of sensors.

The method may further include providing display information indicating when the first sensor is at a center direction of the electronic apparatus.

The determining the locations may include: determining whether an optical signal is sensed by at least two of the plurality of sensors within a predetermined threshold time; when the optical signal is sensed by the at least two sensors as a result of the determining, comparing magnitudes of the sensed optical signals sensed by the at least two of the plurality of sensors; and determining a location of a speaker which outputs the optical signal based on a location of the sensor which senses a greatest magnitude of the optical signal.

The optical signal may be at least one of visible rays and non-visible rays. For example, the non-visible rays may include infrared rays.

According to an aspect of still another exemplary embodiment, there is provided a method for setting an output channel of a speaker in an electronic apparatus, the method including: receiving location information of a plurality of speakers from a location detecting apparatus; determining audio output channels corresponding to the plurality of speakers based on the location information of the plurality of speakers; processing input audio signals into audio signals corresponding to the determined audio output channels; and transmitting the processed audio signals to the plurality of speakers through the audio output channels corresponding to the plurality of speakers.

The determining the audio output channels may include determining a number of regions defined by the location detecting apparatus in which the plurality of speakers are placed based on the location information of the plurality of speakers, and determining the audio output channels of the plurality of speakers further based on the determined number of regions.

The determining the audio output channels may include: when channels of the input audio signals are 5.1 channels and the determined number of regions in which the plurality of speakers are placed is five, determining the audio output channels of the plurality of speakers as 5.1 channels.

The processing may include, when a number of the determined audio output channels is less than a number of the channels of the input audio signals, down-mixing the input audio signals based on the determined audio output channels.

The method may further include: receiving a user command; when the user command is input, transmitting a control signal to output an optical signal to the plurality of speakers; and obtaining, by the location detecting apparatus, the location information of the plurality of speakers using the optical signal output from the plurality of speakers.

According to an aspect of still another exemplary embodiment, there is provided a system for providing multi-channel audio signals including a plurality of speakers configured to output the multi-channel audio signals; and a multi-channel audio generator configured to obtain location information of the plurality of speakers, determine audio output channels of the multi-channel audio signals based on the location information of the plurality of speakers, and transmit the multi-channel audio signals corresponding to the determined audio output channels to the plurality of speakers.

The multi-channel audio signals may have a multi-channel audio format determined according to a location distribution of the plurality of speakers.

The multi-channel audio generator may process an input audio signal according to the determined multi-channel audio format.

The location distribution of the plurality of speakers may be determined based on different regions defined according to a multi-channel audio format of an input audio signal from an external source.

The multi-channel audio generator may down-mix an input audio signal when the determined audio output channels have a lower number of channels than channels of the input audio signal.

### BRIEF DESCRIPTION OF THE DRAWING FIGURES

The above and/or other aspects will be more apparent by describing in detail exemplary embodiments, with reference to the accompanying drawings, in which:

FIG. 1 is an example view illustrating a system for setting an output channel of a speaker according to an exemplary embodiment;

FIG. 2 is a block diagram of an electronic apparatus according to an exemplary embodiment;

FIG. 3 is a block diagram of a location detecting apparatus according to an exemplary embodiment;

FIG. 4 is a view illustrating a sensor and a comparator of a location detecting apparatus according to an exemplary embodiment;

FIG. 5 is a top view illustrating a location detecting apparatus according to an exemplary embodiment;

FIG. 6 is a perspective view illustrating a location detecting apparatus according to an exemplary embodiment;

FIG. 7 is an example view for explaining a method for setting an audio output channel of a speaker according to an exemplary embodiment;

FIG. 8 is an example view for explaining a method for setting audio output channels of a plurality of speakers when an optical signal output from a speaker is sensed by two sensors according to an exemplary embodiment;

FIG. 9 is an example view for explaining a method for setting audio output channels of a plurality of speakers when at least two speakers among the plurality of speakers are placed in the same region defined by a location detection apparatus according to an exemplary embodiment;

FIG. 10 is an example view for explaining a method for setting audio output channels of a plurality of speakers when at least two speakers among the plurality of speakers are placed in the same region defined by a location detection apparatus according to another exemplary embodiment;

FIG. 11 is an example view for explaining a method for setting audio output channels of a plurality of speakers when at least two speakers among the plurality of speakers are placed in the same region defined by a location detection apparatus according to still another exemplary embodiment;

FIG. 12 is an example view for explaining a method for setting an audio output channel of each speaker when a plurality of speakers are respectively placed in three of five regions defined by a location detection apparatus according to an exemplary embodiment;

FIG. 13 is an example view for explaining a method for setting an audio output channel of a plurality of speaker that are placed in four of five regions defined by a location detection apparatus according to an exemplary embodiment;

FIG. 14 is an example view for explaining a method for setting an audio output channel of a speaker that is placed in one of five regions defined by a location detection apparatus according to an exemplary embodiment;

FIG. 15 is a flowchart illustrating a method for detecting locations of a plurality of speakers according to an exemplary embodiment;

FIG. 16 is a flowchart illustrating a method for determining locations of a plurality of speakers when an optical signal from a speaker is sensed by a plurality of sensors according to an exemplary embodiment;

FIG. 17 is a flowchart illustrating a method for setting output channels of a plurality of speakers which output audio signals according to an exemplary embodiment; and

FIG. 18 is a flowchart illustrating a method for obtaining distance information of a plurality of speakers according to an exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

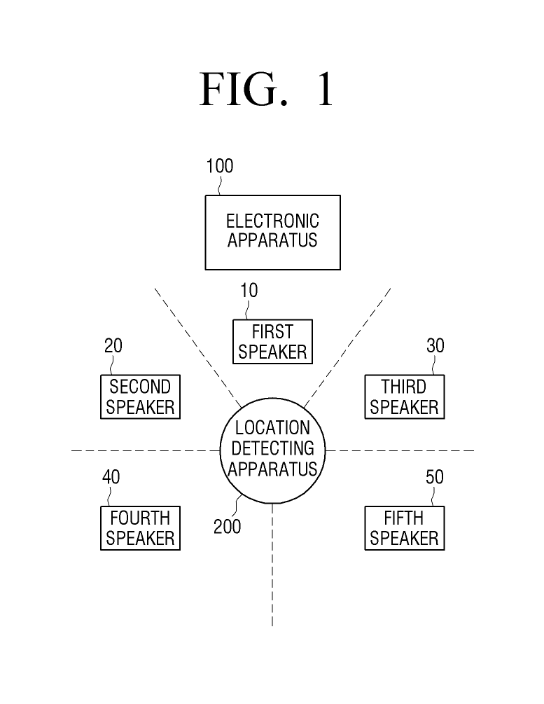

FIG. 1 is an example view illustrating a system for setting an output channel of a speaker according to an exemplary embodiment.

Herein, for illustrative purposes, a 5.1 channel sound system having five audio output channels including front left and front right channels, a center channel, rear left and rear right channels is described. However, this should not be construed as limiting and exemplary embodiments may be applied to any other multi-channel sound system such as a 6.1 or 7.1 channel sound system.

As shown in FIG. 1, a system for setting an output channel of a speaker includes a plurality of speakers, first to fifth speakers 10-50, an electronic apparatus 100, and a location detecting apparatus 200. The first to fifth speakers 10 to 50 communicate with the electronic apparatus 100 in a wired or wireless manner to receive audio signals output from the electronic apparatus 100 and output the received audio signals as audible sounds. In an exemplary embodiment, the first to fifth speakers 10 to 50 may output optical signals according to a control command of the electronic apparatus 100. The optical signal may be infrared rays (IR). However, this should not be considered as limiting. In an alternative embodiment, for example, the first to fifth speakers 10 to 50 may output radio frequency (RF) signals which enable bidirectional communications. The electronic apparatus 100 may set an output channel for each of the first to fifth speakers 10 to 50 and may be a display apparatus such as a set-top box, a home theater, and a smart television (TV). Specifically, the electronic apparatus 100 may determine audio output channels of the first to fifth speakers 10 to 50 based on location information of the first to fifth speakers 10 to 50 received from the location detecting apparatus 200. Accordingly, when audio signals are input from an external source, the electronic apparatus 100 processes the input audio signals according to the audio output channels, which are determined for the first to fifth speakers 10 to 50, and output the audio signals to the first to fifth speakers 10 to 50.

The location detecting apparatus 200 may sense optical signals which are output from the first to fifth speakers 10 to 50 through a plurality of sensors (not shown), detect locations of the first to fifth speakers 10 to 50 based on the optical signals sensed by the plurality of sensors, and transmit corresponding location information to the electronic apparatus 100. In an exemplary embodiment, the location detecting apparatus 200 is disposed within a predetermined range from the electronic apparatus 100 and communicates with the electronic apparatus 100, senses the optical signals output from the first to fifth speakers 10 to 50, determines locations of the first to fifth speakers 10 to 50 based on the sensed optical signals, and transmits corresponding location information to the electronic apparatus 100. Accordingly, as described above, the electronic apparatus 100 may determine the audio output channels corresponding to the first to fifth speakers 10 to 50 based on the location information of the first to fifth speakers 10 to 50 received from the location detecting apparatus 200. Also, the location detecting apparatus 200 may be mounted in the electronic apparatus 100 and may sense the optical signals output from the first to fifth speakers 10 to 50. In the exemplary embodiment of FIG. 1, the location detecting apparatus 200 is provided separately from the electronic apparatus 100 and communicates with the electronic apparatus 100.

The location detecting apparatus 200, which is separated from the electronic apparatus 100 by a predetermined distance, transmits a user command to output optical signals of the first to fifth speakers 10 to 50 to the electronic apparatus 100 according to a user command. Accordingly, the electronic apparatus 100 transmits a control signal to output optical signals to the first to fifth speakers 10 to 50 connected to the electronic apparatus 100 in a wired or wireless manner. At this time, the electronic apparatus 100 may first transmit the control signal to output the optical signal to one of the first to fifth speakers 10 to 50 which satisfies a predetermined condition and then may transmit the control signal to the other speakers in sequence. However, this should not be considered as limiting. For example, the electronic apparatus 100 may simultaneously transmit the control signal to output the optical signal to the first to fifth speakers 10 to 50.

When the control signal is received, the first to fifth speakers 10 to 50 output the optical signals, which are, for example, IR signals, so that the location detecting apparatus 200 may sense the optical signals output from the first to fifth speakers 10 to 50. Specifically, the location detecting apparatus 200 may include a plurality of sensors which are placed in different regions. The plurality of sensors, which are placed in different regions, sense the optical signals output from the first to fifth speakers 10 to 50 and determine where the first to fifth speakers 10 to 50 are placed according to a result of the sensing by the plurality of sensors.

For example, one of the plurality of sensors may be placed in a center direction of the location detecting apparatus 200 and may sense an optical signal that is output from the first speaker 10 from among the first to fifth speakers 10 to 50. When the optical signal output from the first speaker 10 is sensed by the sensor placed in the center direction, the location detecting apparatus 200 determines that the first speaker 10 is placed in the center direction of the electronic apparatus 100 and transmits corresponding location information of the first speaker 10 to the electronic apparatus 100. When the location information of the first speaker 10 is received from the location detecting apparatus 200, the electronic apparatus 100 determines that an audio output channel of the first speaker 10 is a center output channel based on the received location information. Accordingly, when outputting an audio signal input from an external source through the first speaker 10, the electronic apparatus 100 may process the input audio signal into an audio signal corresponding to the center output channel and may transmit the processed signal to the first speaker 10. Accordingly, the audio signal to be output through the first speaker 10 may be processed into the audio signal to be output through the center output channel.

As described above, the electronic apparatus 100 according to an exemplary embodiment determines the respective audio output channels of the first to fifth speakers 10 to 50 based on the location information of the first to fifth speakers 10 to 50 received from the location detecting apparatus 200, processes the input audio signals according to the determined audio output channels, and transmits the processed audio signals to the first to fifth speakers 10 to 50, respectively. Accordingly, the user is not required to manually set the audio output channels for the first to fifth speakers 10 to 50. In the above, elements of the speaker output channel setting system are described. Hereinafter, configurations of the electronic apparatus 100 and the location detecting apparatus 200 of the speaker output channel setting system will be described in detail.

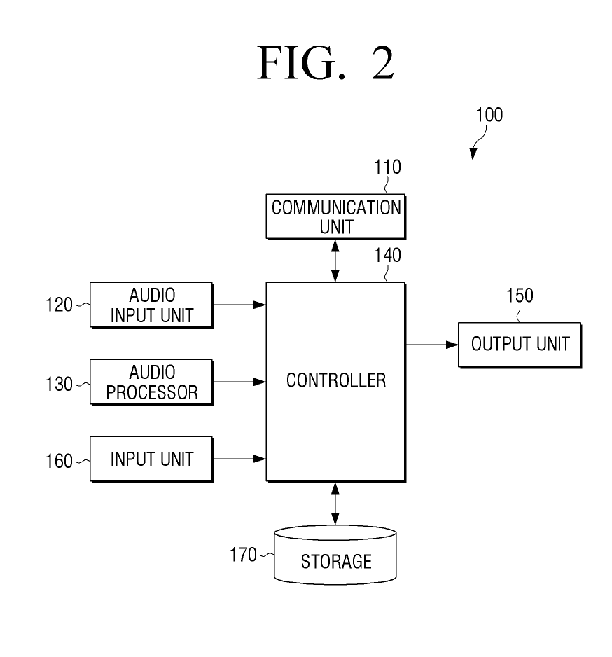

FIG. 2 is a block diagram illustrating an electronic apparatus according to an exemplary embodiment.

As shown in FIG. 2, the electronic apparatus 100 includes a communication unit 110, an audio input unit 120, an audio processor 130, and a controller 140.

The communication unit 110 communicates with the first to fifth speakers 10 to 50 and the location detecting apparatus 200 in a wired or wireless manner. In an exemplary embodiment, the communication unit 110 may transmit audio signals, which are input through the audio input unit 120 and processed according to respective audio output channels, to the first to fifth speakers 10 to 50. Also, the communication unit 110 may receive location information of the first to fifth speakers 10 to 50 from the location detecting apparatus 200 or may transmit, to the first to fifth speakers 10 to 50, a control signal to output an optical signal. In addition, the communication unit 110 may receive a content from an external server or an external apparatus.

The audio processor 130 processes the audio signals which are input through the audio input unit 120 into audio signals corresponding to audio output channels. For example, if channels of input audio signals are 5.1 channels and audio output channels of the first to fifth speakers 10 to 50 are determined to be 5.1 channels, the audio processor 130 may process the input audio signals into audio signals corresponding to the 5.1 output channels.

The controller 140 controls an overall operation of the electronic apparatus 100 and controls to output, through an output unit 150 of the electronic apparatus 100, a content which is received from an external server or an external apparatus through the communication unit 110. In an exemplary embodiment, when the location information of the first to fifth speakers 10 to 50 is received from the location detecting apparatus 200 through the communication unit 110, the controller 140 determines the audio output channels for the first to fifth speakers 10 to 50 based on the received location information. The controller 140 controls the audio processor 130 to process the audio signals input through the audio input unit 120 into audio signals corresponding to the audio output channels which are determined for the first to fifth speakers 10 to 50. According to the control command, the audio processor 130 audio-processes the audio signals input through the audio input unit 120 into the audio signals corresponding to the determined audio output channels. When the input audio signals are processed into the audio signals corresponding to the determined audio output channels, the controller 140 controls the communication unit 110 to transmit the processed audio signals to the corresponding first to fifth speakers 10 to 50, respectively. Accordingly, the communication unit 110 transmits the processed audio signals to the first to fifth speakers 10 to 50 through the determined audio output channels.

Specifically, when a user command is input through an input unit 160 of the electronic apparatus 100, the controller 140 controls the communication unit 110 to transmit a control signal to output an optical signal to the first to fifth speakers 10 to 50. According to an exemplary embodiment, a storage 170 of the electronic apparatus 100 may store identification information of the first to fifth speakers 10 to 50. In an exemplary embodiment, the controller 140 may first transmit the control signal to output the optical signal to, for example, the first speaker 10 and transmit the control signal to the other speakers 20 to 50 in sequence, based on the identification information of the first to fifth speakers 10 to 50 stored in the storage 170. Accordingly, the first to fifth speakers 10 to 50 output optical signals based on the control signal which is output from the electronic apparatus 100, and the location detecting apparatus 200 senses the optical signals which are output from the first to fifth speakers 10 to 50, determines locations of the first to fifth speakers 10 to 50, and transmits corresponding location information to the electronic apparatus 100.

When the location information of the first to fifth speakers 10 to 50 is received through the communication unit 110, the controller 140 determines the number of regions, defined by the location detecting apparatus 200, in which the first to fifth speakers 10 to 50 are placed based on the location information of the first to fifth speakers 10 to 50 received from the location detecting apparatus 200. Next, the controller 140 may determine the audio output channels of the first to fifth speakers 10 to 50 according to the determined number of regions.

According to an exemplary embodiment, it may be determined that channels of audio signals input through the audio input unit 120 are 5.1 channels and the number of regions, defined by the location detecting apparatus 200, in which the plurality of speakers are placed is 5. In this case, the controller 140 may determine the audio output channels of the first to fifth speakers 10 to 50 as 5.1 channels. When the audio output channels corresponding to the first to fifth speakers 10 to 50 are determined as described above, the audio processor 130 processes the input audio signals into audio signals corresponding to the determined audio output channels, e.g., 5.1 channels. Accordingly, the communication unit 110 may transmit the processed audio signals to the first to fifth speakers 10 to 50 through the determined audio output channels.

On the other hand, when it is determined that channels of audio signals input through the audio input unit 120 is 5.1 channels and the number of regions, defined by the location detecting apparatus 200, in which the first to fifth speakers 10 to 50 are placed is under 5, the controller 140 may determine audio output channels corresponding to the number of regions in which the first to fifth speakers 10 to 50 are placed. In an exemplary embodiment, when the number of determined audio output channels is less than the number of channels of input audio signals, the controller 140 may control the audio processor 130 to down-mix the input audio signals based on the determined audio output channels. For example, it may be determined that channels of input audio signals are 5.1 channels and the number of audio output channels determined for the first to fifth speakers 10 to 50 is 3. In this case, the controller 140 may control the audio processor 130 to down-mix the audio signals of the 5.1 channels into audio signals of 3 channels and may control the communication unit 110 to transmit the down-mixed audio signals to the first to fifth speakers 10 to 50. Accordingly, the audio processor 130 processes the audio signals of the 5.1 channels such that the audio signals of the 5.1 channels are down-mixed into audio signals corresponding to the audio output channels which are determined as 3 channels. Accordingly, the communication unit 110 may transmit the down-mixed audio signals to the first to fifth speakers 10 to 50 through the audio output channels which are determined as 3 channels.

Hereinafter, a detailed configuration of the location detecting apparatus 200 according to an exemplary embodiment will be explained in detail.

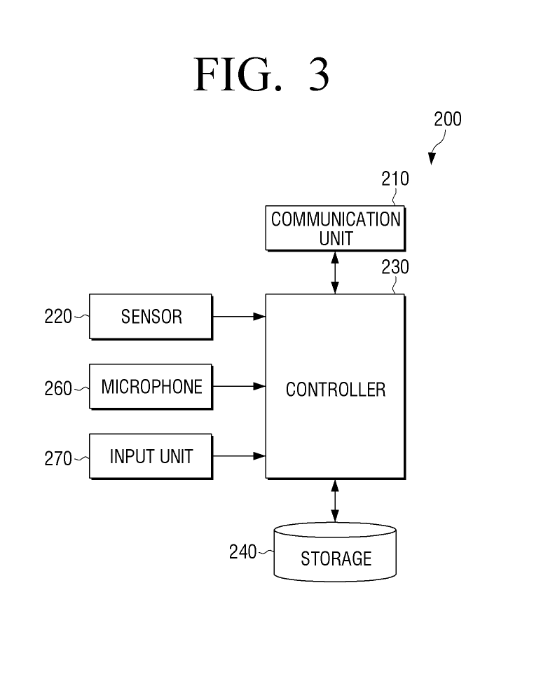

FIG. 3 is a block diagram illustrating a location detecting apparatus according to an exemplary embodiment.

As shown in FIG. 3, the location detecting apparatus 200 includes a communication unit 210, a sensor 220, and a controller 230.

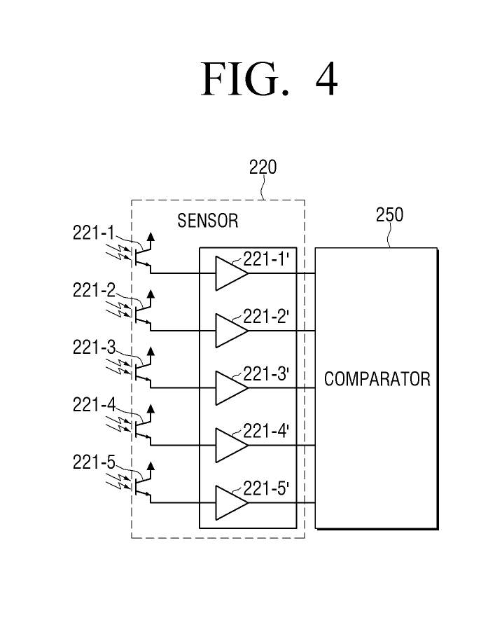

The communication unit 210 communicates with the first to fifth speakers 10 to 50 and the electronic apparatus 100. The sensor 220 senses optical signals which are output from the first to fifth speakers 10 to 50 and may include a plurality of sensors (e.g., first to fifth sensors 221-1 to 221-5 as shown in FIG. 4) which are placed in different regions defined by the location detecting apparatus 200. As described above, the optical signals output from the first to fifth speakers 10 to 50 may be IR signals. However, this should not be considered as limiting. In an alternative embodiment, for example, the signals output from the first to fifth speakers 10 to 50 may be RF signals which enable bidirectional communications. Also, the controller 230 determines locations of the first to fifth speakers 10 to 50 according to a result of the sensing by the first to fifth sensors 221-1 to 221-5 and controls the communication unit 210 to transmit the location information of the first to fifth speakers 10 to 50 to an external apparatus (e.g., the electronic apparatus 100). According to the control command, the communication unit 210 transmits the location information of the first to fifth speakers 10 to 50 to the electronic apparatus 100.

On the other hand, the sensor 220, which senses the optical signals output from the first to fifth speakers 10 to 50, may include a first sensor 221-1 which is placed in, for example, a center direction of the location detecting apparatus 200, second and third sensors 221-2 and 221-5 which are placed in left and right front directions of the location detecting apparatus 200, and fourth and fifth sensors 221-3 and 221-4 which are placed in left and right rear directions of the location detecting apparatus 200, relative to the electronic apparatus 100. Accordingly, the first to fifth sensors 221-1 to 221-5 may sense the optical signals which are output from the plurality of speakers, and the controller 230 may transmit the location information of the first to fifth speakers 10 to 50 to the electronic apparatus 100 based on a result of the sensing by the first to fifth sensors 221-1 to 221-5.

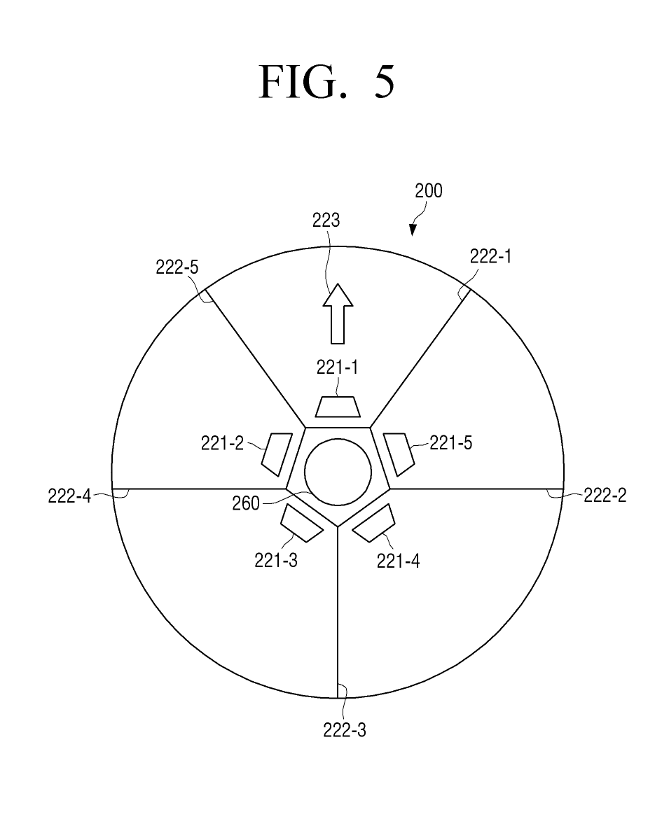

According to an exemplary embodiment, the sensor 220 may further include partitions 222-1 to 222-5, as shown in FIG. 5. The partitions 222-1 to 222-5 are configured to control the optical signals output from the first to fifth speakers 10 to 50 to be output only to the first to fifth sensors 221-1 to 221-5 which are placed in regions corresponding to the first to fifth speakers 10 to 50. In an exemplary embodiment, the partitions 222-1 to 222-5 are positioned between the first to fifth sensors 221-1 to 221-5 such that the first sensor 221-1 senses only the optical signal that is output from the first speaker 10 placed at a center of the location detecting apparatus 200, and the second and third sensors 221-2 and 221-5 sense only the optical signals that are output from the second and third speakers 20 and 30 placed at left and right fronts of the location detecting apparatus 200. Also, the fourth and fifth sensors 221-3 and 221-4 may sense only the optical signals that are output from the fourth and fifth speakers 40 and 50 placed at left and right rears of the location detecting apparatus 200.

According to another exemplary embodiment, the sensor 220 may further include a display 223 (not shown) indicating when the first sensor 221-1 is placed in the center direction 223 of the electronic apparatus 100, as shown in FIG. 5. By using the display, the user may place the first sensor 221-1 of the sensor 220 to be positioned in the center direction 223 of the electronic apparatus 100. Accordingly, the first to fifth sensors 221-1 to 221-5 may sense the optical signals respectively output from the first to fifth speakers 10 to 50 which are placed in respective directions from the location detecting apparatus 200. As described above, when the optical signals are sensed by the first to fifth sensors 221-1 to 221-5, the controller 230 determines locations of the first to fifth speakers 10 to 50 and transmits location information according to a result of the determining to the electronic apparatus 100 through the communication unit 210. Accordingly, the electronic apparatus 100 may determine audio output channels of the first to fifth speakers 10 to 50 based on the location information of the first to fifth speakers 10 to 50 received from the location detecting apparatus 200.

Hereinafter, an operation of determining locations of the first to fifth speakers 10 to 50 according to a result of sensing by the first to fifth sensors 220-1 to 220-5 will be explained in detail with reference to FIG. 4.

FIG. 4 is a view illustrating a sensor and a comparator of a location detecting apparatus according to an exemplary embodiment.

As shown in FIG. 4, the sensor 220 includes the first to fifth sensors 221-1 to 221-5, and first to fifth signal converters 221-1′ to 221-5′ corresponding to the first to fifth sensors 221-1 to 221-5. The comparator 250 compares magnitudes of optical signals of the first to fifth speakers 10 to 50 that are sensed by the first to fifth sensors 221-1 to 221-5 and detects a sensor that senses the greatest magnitude of the optical signal. It should be noted that, in an exemplary embodiment, the comparator 250 may be implemented to be a part of the controller 230.

Specifically, the first to fifth sensors 221-1 to 221-5 may sense optical signals which are output from the first to fifth speakers 10 to 50. When the optical signals of the first to fifth speakers 10 to 50 are sensed by the first to fifth sensors 221-1 to 221-5, the first to fifth signal converters 221-1′ to 221-5′ convert the optical signals of the first to fifth speakers 10 to 50 sensed by the first to fifth sensors 221-1 to 221-5 into electric signals. When the optical signals of the first to fifth speakers 10 to 50 are converted into the electric signals by the first to fifth signal converters 221-1′ to 221-5′, the comparator 250 may compare magnitudes of the electric signals, which are respectively converted by the first to fifth signal converters 221-1′ to 221-5′, and may determine the sensor that senses the greatest magnitude of the optical signal.

According to an exemplary embodiment, the first to fifth sensors 221-1 to 221-5 may sense the optical signals that are output from the first to fifth speakers 10 to 50 placed respectively corresponding to the regions of the first to fifth sensors 221-1 to 221-5. For example, the optical signal output through the first speaker 10 may be sensed only by the first sensor 221-1 that is placed in the center direction of the electronic apparatus 100. In this case, the signals converted by the second to fifth signal converters 221-2′ to 221-5′ except the first signal converter 221-1′ have a magnitude of substantially 0. When all of the magnitudes of the signals converted by the first to fifth signal converters 221-1′ to 221-5′ are obtained, the comparator 250 compares the magnitudes of the signals. In an exemplary embodiment, the location detecting apparatus 200 may include a storage 240, as shown in FIG. 3, to store the magnitudes of the signals converted by the first to fifth signals converters 221-1′ to 221-5′. As a result of the comparing, when the magnitudes of the signals converted by the second to fifth signal converters 221-2′ to 221-5′ except the first signal converter 221-1′ are determined to be substantially 0, the comparator 250 determines that the optical signal output from the first speaker 10 is sensed by the first sensor 221-1. According to a result of the comparing by the comparator 250, the controller 230 may transmit location information indicating that the first speaker 10 is placed at the region corresponding to the first sensor 221-1, i.e., the center of the electronic apparatus 100.

According to an exemplary embodiment, the first and second sensors 221-1 and 221-2 may sense the optical signal that is output from the second speaker 20. When the optical signal of the second speaker 20 is sensed only by the first and second sensors 221-1 and 221-2, signals converted by the third to fifth signal converters 221-3′ to 221-5′ except the first and second signal converters 221-1′ and 221-2′ may have a magnitude of substantially 0. In an exemplary embodiment, when all of the magnitudes of the signals converted by the first to fifth signals converters 221-1′ to 221-5′ are stored in the storage 240, the comparator 250 compares the magnitudes of the signals stored in the storage 240. When the magnitudes of the signals converted by the third to fifth signal converters 221-3′ to 221-5′ except the first and second signal converters 221-1 and 221-2′ are determined to be substantially 0, the comparator 250 compares the magnitudes of the signals converted by the first and second signal converters 221-1′ and 221-2′. When it is determined that the magnitude of the signal converted by the second signal converter 221-2′ is greater than that of the first signal converter 221-1′ as a result of the comparing, the comparator 250 determines that the second speaker 20 is placed in a region corresponding to the direction of the second sensor 221-2. According to a result of the determining, the controller 230 transmits location information indicating that the second speaker 20 is placed at the region corresponding to the second sensor 221-2, i.e., the left front of the electronic apparatus 100.

Accordingly, the electronic apparatus 100 may determine audio output channels for the first to fifth speakers 10 to 50 based on the location information transmitted from the location detecting apparatus 200. Accordingly, when audio signals are input through the audio output unit 120, the controller 140 of the electronic apparatus 100 processes the input audio signals into signals corresponding to the determined audio output channels and transmits the processed signals to the first to fifth speakers 10 to 50, respectively.

According to another exemplary embodiment, the location detecting apparatus 200 may further include a microphone 260 to receive audio test signals which are output through the first to fifth speakers 10 to 50.

Specifically, for example, when a user command is input through an input unit 270 of the location detecting apparatus 200, the controller 230 requests the electronic apparatus 100 to output an audio test signal. Accordingly, the electronic apparatus 100 transmits a control signal to output the audio test signal to the first to fifth speakers 10 to 50. However, this should not be considered as limiting. The electronic apparatus 100 may transmit the control signal to output the audio test signal to the first to fifth speakers 10 to 50 without receiving the request for the audio test signal from the location detecting apparatus 200. Accordingly, the first to fifth speakers 10 to 50 output audio test signals based on the control signal transmitted from the electronic apparatus 100, and the microphone 260 receives the audio test signals respectively output from the first to fifth speakers 10 to 50.

When the audio test signals respectively output from the first to fifth speakers 10 to 50 are input to the microphone 260 as described above, the controller 230 transmits response information including identification information of the first to fifth speakers 10 to 50 to the electronic apparatus 100. Accordingly, the controller 140 of the electronic apparatus 100 obtains time information on a time interval from when the control signal to output the audio test signal is transmitted to the first to fifth speakers 10 to 50 to when the response information on the first to fifth speakers 10 to 50 is received through the location detecting apparatus 200. Accordingly, the controller 140 may control a timing of transmitting the audio signals to the first to fifth speakers 10 to 50 based on the obtained time information with respect to the first to fifth speakers 10 to 50.

For example, the first speaker 10 may be set to a center output channel, the second and third speakers 20 and 30 may be set to left and right front output channels, and the fourth and fifth speakers 40 and 50 may be set to left and right rear output channels. When it is determined that the fifth speaker 50 is farthest from the electronic apparatus 100 based on distance information of the first to fifth speakers 10 to 50, the controller 140 may delay transmitting audio signals to the first to fourth speakers 10 to 40 based on a time required for the audio signal, which is processed into the signal corresponding to the right rear output channel to arrive at the fifth speaker 50. Accordingly, a delay may not occur in sounds output through the first to fifth speakers 10 to 50.

Hereinafter, a method of sensing the optical signals output from the first to fifth speakers 10 to 50 through the first to fifth sensors 221-1 to 221-5 placed in different regions will be described in detail.

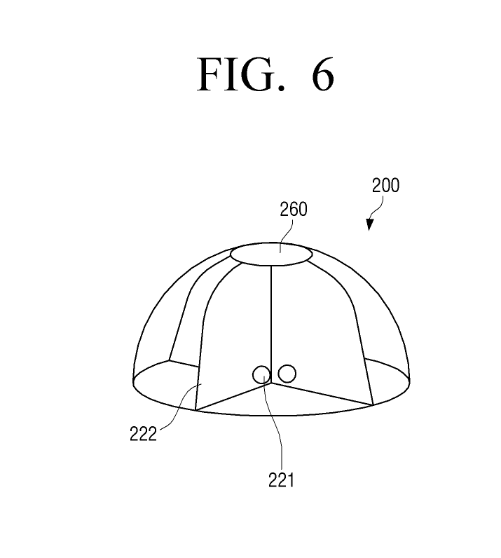

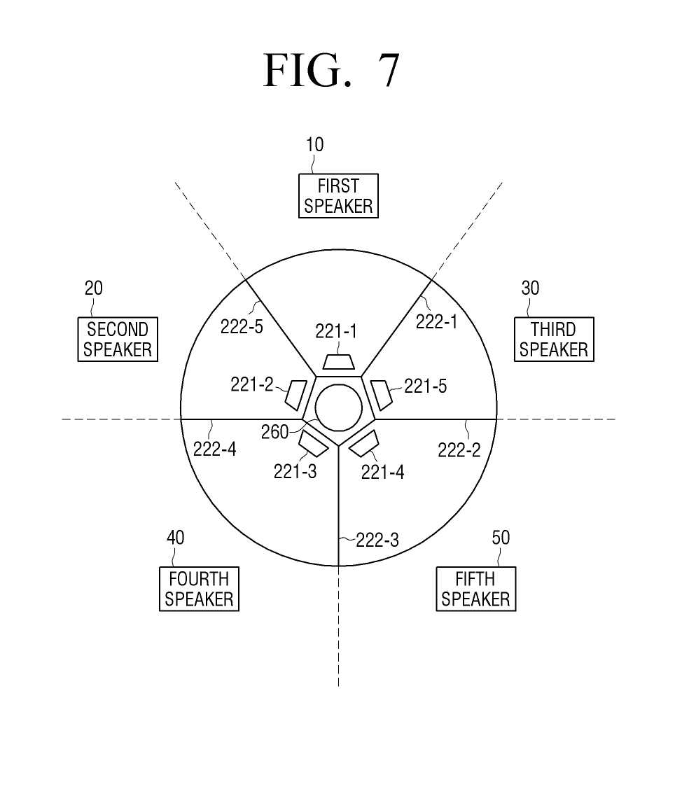

FIG. 5 is a top view illustrating a location detecting apparatus according to an exemplary embodiment, FIG. 6 is a perspective view illustrating a location detecting apparatus according to an exemplary embodiment, and FIG. 7 is an example view for explaining a method for setting an audio output channel of a speaker according to an exemplary embodiment.

As shown in FIGS. 5 to 7, the location detecting apparatus 200 may be implemented in, for example, a semi-spherical shape. The location detecting apparatus 200, which is implemented in the semi-spherical shape, includes the first to fifth sensors 221-1 to 221-5 and the partitions 222-1 to 222-5. The partitions 222-1 to 222-5 define different regions in which the first to fifth sensors 221-1 to 221-5 are located. In an exemplary embodiment, the first sensor 221-1 from among the first to fifth sensors 221-1 to 221-5 placed in different regions faces a center of the electronic apparatus 100 to sense the optical signal output from the first speaker 10 which is placed, for example, in the center direction of the electronic apparatus 100. The second and third sensors 221-2 and 221-5 may be placed in left and right front directions of the location detecting apparatus 200, relative to the electronic apparatus 100. Accordingly, the second and third sensors 221-1 and 221-5 may sense the optical signals respectively output from the second and third speakers 20 and 30 which are placed in the left and right front directions of the location detecting apparatus 200, relative to the electronic apparatus 100. Also, the fourth and fifth sensors 221-3 and 221-4 may be located in left and right rear directions of the location detecting apparatus 200, relative to the electronic apparatus 100. Accordingly, the fourth and fifth sensors 221-3 and 221-4 may sense the optical signals respectively output from the fourth and fifth speakers 40 and 50 which are placed in the left and right rear directions of the location detecting apparatus 200, relative to the electronic apparatus 100.

As described above, the partitions 222-1 to 222-5 may be located between the first to fifth sensors 221-1 to 221-5 to define different regions in which the first to fifth sensors 221-1 to 221-5 are located and sense the optical signals output from the first to fifth speakers 10 to 50. The partitions 222-1 to 222-5 are used to provide the optical signals output from the first to fifth speakers 10 to 50 to the first to fifth sensors 221-1 to 221-5 placed in regions corresponding to the first to fifth speakers 10 to 50. In an exemplary embodiment, the partitions 222-1 to 222-5 are located between the first to fifth sensors 221-1 to 221-5 such that the first sensor 221-1 senses the optical signal that is output from the first speaker 10 placed at the center of the location detecting apparatus 200, and the second and third sensors 221-2 and 221-5 sense the optical signals that are output from the second and third speakers 20 and 30 placed at the left and right fronts of the location detecting apparatus 200. Also, the fourth and fifth sensors 221-3 and 221-4 may sense the optical signals that are output from the fourth and fifth speakers 40 and 50 located at the left and right rears of the location detecting apparatus 200.

According to another exemplary embodiment, the sensor 220 may further include a display (not shown) indicating when the first sensor 221-1 is placed in the center direction 223 of the electronic apparatus 100. By using the display, the user may place the first sensor 221-1 to be positioned in the center direction 223 of the electronic apparatus 100. Accordingly, as described above, the first to fifth sensors 221-1 to 221-5 may sense the optical signals output from the first to fifth speakers 10 to 50 positioned in their respective directions.

When the optical signals are sensed by the first to fifth sensors 221-1 to 221-5 as described above, the controller 230 may determine locations of the first to fifth speakers 10 to 50. According to an exemplary embodiment, the storage 240 of the location detecting apparatus 200 may store identification information of the first to fifth sensors 221-1 to 221-5. Also, the storage 240 may store placement information of the first to fifth sensors 221-1 to 221-5. As described above, in an exemplary embodiment, the electronic apparatus 100 may first transmit a control signal to output an optical signal to, for example, the first speaker 10 based on the pre-stored identification information of the first to fifth speakers 10 to 50 and transmit the control signal to output the optical signal to the other speakers 20 to 50 in sequence. The first to fifth speakers 10 to 50 output the optical signals in sequence according to the control signal, and accordingly, the first to fifth sensors 221-1 to 221-5 sense the optical signals output from the first to fifth speakers 10 to 50 in sequence. When the optical signals of the first to fifth speakers 10 to 50 are sensed as described above, the controller 230 may determine current locations of the first to fifth speakers 10 to 50 based on a result of the sensing by the first to fifth sensors 221-1 to 221-5 and the placement information of the first to fifth sensors 221-1 to 221-5 stored in the storage 240.

In an exemplary embodiment, the controller 230 may compare magnitudes of optical signals sensed by at least two of the first to fifth sensors 221-1 to 221-5 within a predetermined threshold time. Next, the controller 230 may determine a location of the speaker of which optical signal is sensed by at least two of the first to fifth sensors 221-1 to 221-5 based on the placement information of the sensor which senses the greatest magnitude of optical signal. In this manner, the controller 230 may determine the locations of the first to fifth speakers 10 to 50 according to a result of the sensing by the first to fifth sensors 221-1 to 221-5, and may transmit corresponding location information to the electronic apparatus 100. Accordingly, the electronic apparatus 100 determines a number of regions in which the first to fifth speakers 10 to 50 are placed based on the location information of the first to fifth speakers 10 to 50 transmitted from the location detecting apparatus 200 and determines audio output channels corresponding to the first to fifth speakers 10 to 50 according to the determined number of regions.

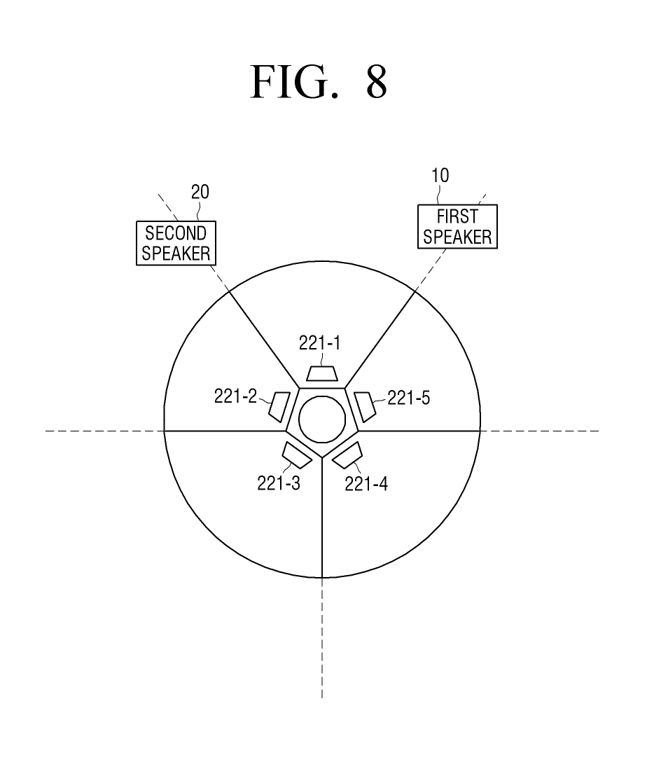

FIG. 8 is an example view for explaining a method for setting an audio output channel of a speaker when an optical signal output from a speaker is sensed by two sensors according to an exemplary embodiment.

As shown in FIG. 8, the first speaker 10 may be placed between the center and the right front of the location detecting apparatus 200, and the second speaker 20 may be placed between the center and the left front of the location detecting apparatus 200. In this case, the first and fifth sensors 221-1 and 221-5 may sense the optical signal that is output from the first speaker 10, and the first and second sensors 221-1 and 221-2 may sense the optical signal that is output from the second speaker 20.

When the optical signal of one speaker is sensed by at least two sensors, the controller 230 of the location detecting apparatus 200 may compare respective magnitudes of the optical signals sensed by the at least two sensors and may determine a location of the speaker that outputs the optical signal based on the sensor that senses the greatest magnitude of the optical signal. In this exemplary embodiment, the first and fifth sensors 221-1 and 221-5 may sense the optical signal that is output from the first speaker 10. In this case, the controller 230 compares the magnitude of the optical signal of the first speaker 10 that is sensed by the first sensor 221-1 and the magnitude of the optical signal of the first speaker 10 that is sensed by the fifth sensor 221-5. As a result of the comparing, when it is determined that the magnitude of the optical signal sensed by the first sensor 221-1 is greater than the magnitude of the optical sensor sensed by the fifth sensor 221-5, the controller 230 determines that the first speaker 10 is placed corresponding to first speaker 10, i.e., at the center of the location detecting apparatus 200 based on the pre-stored placement information of the first sensor 221-1. In the same way, the controller 230 compares the magnitude of the optical signal output from the second speaker 20 that is sensed by the first sensor 221-1 and the magnitude of the optical signal output from the second speaker 20 that is sensed by the second sensor 221-2. As a result of the comparing, when it is determined that the magnitude of the optical signal sensed by the second sensor 221-2 is greater than the magnitude of the optical signal sensed by the first sensor 221-1, the controller 230 determines that the second speaker 20 is placed corresponding to the second sensor 221-2, i.e., at the left front of the location detecting apparatus 200 based on the pre-stored placement information of the second sensor 221-2.

Next, the controller 230 transmits location information of the first and second speakers 10 and 20 to the electronic apparatus 100 through the communication unit 210. Accordingly, the controller 140 of the electronic apparatus 100 may set an audio output channel of the first speaker 10 to a center output channel and set an audio output channel of the second speaker 20 to a left front output channel, based on the location information received from the location detecting apparatus 200. Here, it is assumed that a user of the electronic apparatus 100 is located at a side of the location detecting apparatus 200. However, this should not be construed as limiting. For example, if the user of the electronic apparatus 100 is located at a side of the electronic apparatus 100, the controller 140 of the electronic apparatus 100 may set the audio output channel of the first speaker 10 to the center output channel and set the audio output channel of the second speaker 20 to a right rear output channel, based on the location information received from the location detecting apparatus 200.

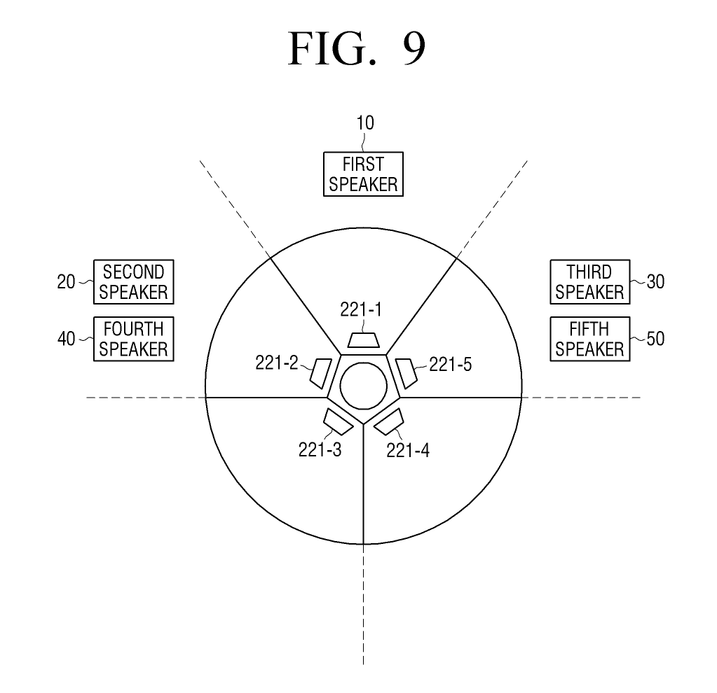

FIG. 9 is an example view for explaining a method for setting audio output channels of a plurality of speakers when at least two speakers among the plurality of speakers are placed in the same region according to an exemplary embodiment.

As shown in FIG. 9, the first speaker 10 may be placed at the center of the location detecting apparatus 200, the second and fourth speakers 20 and 40 may be placed at the left front of the location detecting apparatus 200, and the third and fifth speakers 30 and 50 may be placed at the right front of the location detecting apparatus 200. That is, no speaker is placed at the left and right rears of the location detecting apparatus 200. In this case, only the first, second, and fifth sensors 221-1,221-2, and 221-5 from among the first to fifth sensors 221-1 to 221-5 may sense audio detection signals, e.g., optical signals, output through the first to fifth speakers 10 to 50. That is, the first sensor 221-1 may sense an audio detection signal that is output from the first speaker 10, the second sensor 221-2 may sense audio detection signals that are output firm the second and fourth speakers 20 to 40, and the fifth sensor 221-5 may sense audio detection signals that are output from the third and fifth speakers 30 and 50.

In this case, the controller 230 of the location detecting apparatus 200 determines that the first speaker 10 is placed at the center of the location detecting apparatus 200 according to a result of the sensing by the first sensor 221-1, determines that the second and fourth speakers 20 and 40 and the third and fifth speakers 30 and 50 are respectively placed at the left and right fronts of the location detecting apparatus 200 according to a result of the sensing by the second and third sensors 221-2 and 221-5, and transmits corresponding location information to the electronic apparatus 100. Accordingly, the controller 140 of the electronic apparatus 100 may set an audio output channel of the first speaker 10 to a center output channel, set audio output channels of the second and fourth speakers 20 and 40 to a left front output channel, and set audio output channels of the third and fifth speaker 30 and 50 to a right front output channel, based on the location information received from the location detecting apparatus 200. Here, it is assumed that the user of the electronic apparatus 100 is located at the side of the location detecting apparatus 200. However, this should not be construed as limiting. For example, if the user of the electronic apparatus 100 is located at the side of the electronic apparatus 100, the controller 140 of the electronic apparatus 100 may set the audio output channel of the first speaker 10 to the center output channel, set the audio output channels of the second and fourth speakers 20 and 40 to a right rear output channel, and set the audio output channels of the third and fifth speakers 30 and 50 to a left rear output channel, based on the location information received from the location detecting apparatus 200.

Next, it is determined that the number of regions in which the first to fifth speakers 10 to 50 are located is 3 and is less than the number of channels of input audio signals, e.g., 5.1 channels. Accordingly, the controller 140 transmits an audio signal that is processed, from among audio signals of 5.1 channels input through the audio input unit 120, to be output through the center output channel to the first speaker 10. Also, the controller 140 down-mixes audio signals that are processed to be output through the left front and left rear output channels, processes the down-mixed audio signals to be output through the left front output channel, and transmits the processed audio signals to the second and fourth speakers 20 and 40. Further, the controller 140 down-mixes audio signals that are processed to be output through the right front and right rear output channels, processes the down-mixed audio signals to be output through the right front output channel, and transmits the processed audio signals to the third and fifth speakers 30 and 50. Accordingly, a sound in a 5.1 channel sound format to be output through the left rear output channel may be mixed with a sound to be output through the left front output channel and output through the second and fourth speakers 20 and 40 which are determined to be set to the left front output channel. Also, a sound to be output through the right rear output channel may be mixed with a sound to be output through the right front output channel and output through the third and fifth speakers 30 and 50 which are determined to be set to the right front output channel. Since a technology of down-mixing audio signals to be output through different output channels and outputting the down-mixed audio signals through a single output channel is well known, a detailed description thereof is omitted.

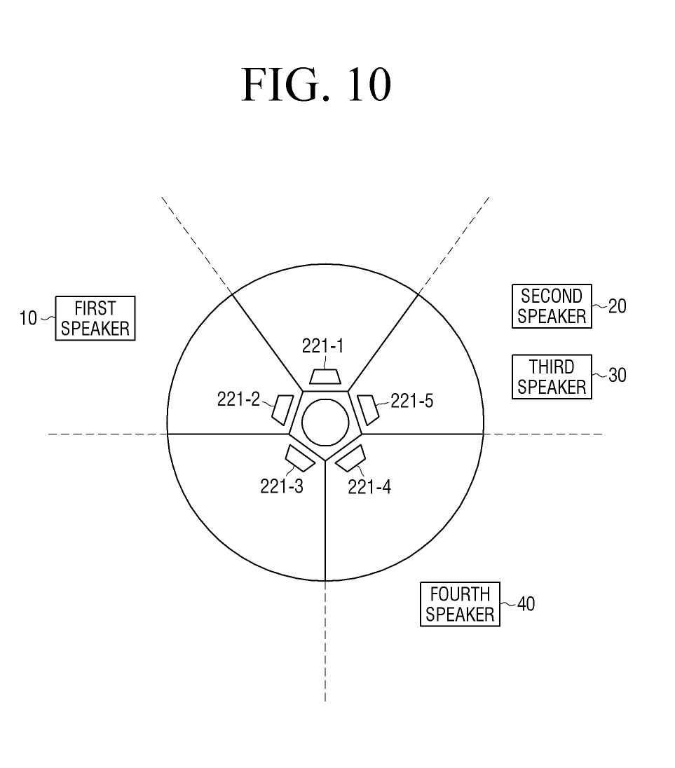

FIG. 10 is an example view for explaining a method for setting audio output channels of a plurality of speakers when at least two speakers among the plurality of speakers are placed in the same region according to another exemplary embodiment.

As shown in FIG. 10, the first speaker 10 may be placed at the left front of the location detecting apparatus 200, the second and third speakers 20 and 30 may be placed at the right front of the location detecting apparatus 200, and the fourth speaker 40 may be placed at the right rear of the location detecting apparatus 200. That is, no speaker may be placed at the center and the left rear of the location detecting apparatus 200. In this case, only the second, fourth, and fifth sensors 221-2, 221-4, and 221-5 from among the first to fifth sensors 221-1 to 221-5 may sense audio detection signals that are output through the first to fourth speakers 10 to 40. That is, the second sensor 221-2 may sense an audio detection signal that is output from the first speaker 10, the fourth sensor 221-4 may sense an audio detection signal that is output from the fourth speaker 40, and the fifth sensor 221-5 may sense audio detection signals that are output from the second and third speakers 20 and 30.

In this case, the controller 230 of the location detecting apparatus 200 determines that the first speaker 10 is placed at the left front of the location detecting apparatus 200 according to a result of the sensing by the second sensor 221-2, determines that the fourth speaker 40 is placed at the right rear of the location detecting apparatus 200 according to a result of the sensing by the fourth sensor 221-3, and determines that the second and third speakers 20 and 30 are placed at the right front of the location detecting apparatus 200 according to a result of sensing by the fifth sensor 221-4. Accordingly, the controller 230 of the location detecting apparatus 200 transmits the location information of the first to fourth speakers 10 to 40 to the electronic apparatus 100 according to a result of the determining.

Accordingly, the controller 140 of the electronic apparatus 100 sets an audio output channel of the first speaker 10 to a left front output channel, sets an audio output channel of the fourth speaker 40 to a right rear output channel, and sets audio output channels of the second and third speakers 20 and 30 to a right front output channel, based on the location information received from the location detecting apparatus 200. Here, it is assumed that the user of the electronic apparatus 100 is located at the side of the location detecting apparatus 200. However, this should not be construed as limiting. For example, if the user of the electronic apparatus 100 is located at the side of the electronic apparatus 100, the controller 140 of the electronic apparatus 100 may set the audio output channel of the first speaker 10 to a right rear output channel, set the audio output channel of the fourth speaker 40 to a left front output channel, based on the location information received from the location detecting apparatus 200, and set the audio output channels of the second and third speakers 20 and 30 to a left rear output channel.

Next, when audio signals of 5.1 channels are input through the audio input unit 120, the controller 140 of the electronic apparatus 100 transmit an audio signal that is processed to be output through the left front channel to the first speaker 10, transmits an audio signal that is processed to be output through the right front output channel to the second and third speakers 20 and 30, and transmits an audio signal that is processed to be output through the right rear output channel to the fourth speaker 40. Here, the controller 140 may down-mix the audio signals that are processed to be output through the left and right front output channels and the audio signal that is output through the center output channel, and may transmit the down-mixed audio signals to the first, second, and third speaker 10 to 30. Also, the controller 140 may down-mix the audio signal that is processed to be output through the right rear channel and the audio signal that is output through the left rear channel, and may transmit the down-mixed audio signals to the fourth speaker 40.

Accordingly, the first speaker 10 may output a sound that is processed into a signal corresponding to the left front output channel and a sound that is processed into a signal corresponding to the center output channel. Also, the second and third speakers 20 and 30 may output a sound that is processed into a signal corresponding to the right front output channel and the sound that is processed into the signal corresponding to the center output channel. Also, the fourth speaker 40 may output a sound that is processed into a signal corresponding to the right rear output channel and a sound that is processed into a signal corresponding to the left rear output channel.

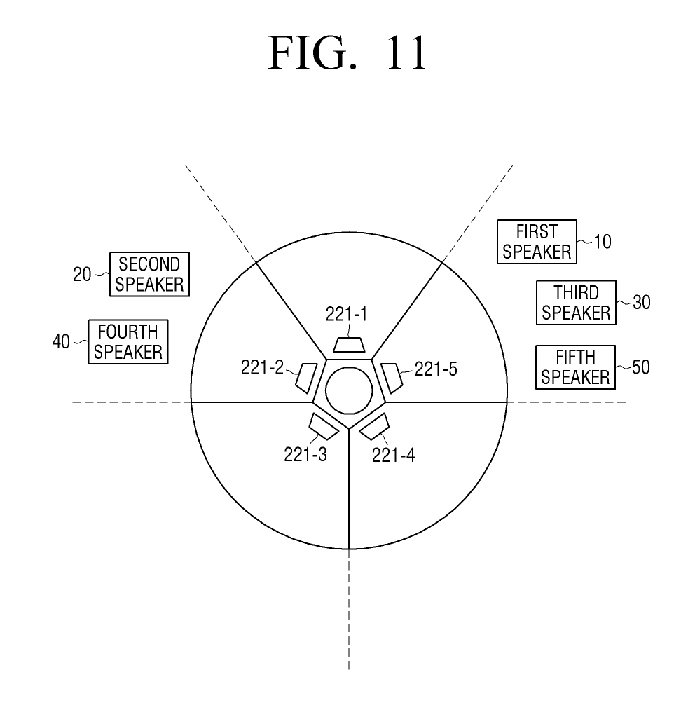

FIG. 11 is an example view for explaining a method for setting audio output channels of a plurality of speakers when at least two speakers among the plurality of speaker are placed in the same region according to still another exemplary embodiment.

As shown in FIG. 11, the first, third, and fifth speakers 10, 30, and 50 may be placed at the right front of the location detecting apparatus 200, and the second and fourth speaker 20 and 40 may be placed at the left front of the location detecting apparatus 200. That is, no speaker is placed at the center and the left and right rears. In this case, only the second and fifth sensors 221-2 and 221-5 from among the first to fifth sensors 221-1 to 221-5 may sense audio detection signals that are output through the first to fifth speakers 10 to 50. That is, the second sensor 221-2 may sense audio detection signals that are output from the second and fourth speakers 20 and 40, and the fifth sensor 221-5 may sense audio detection signals that are output from the first, third, and fifth speakers 10, 30, and 50.

In this case, the controller 230 of the location detecting apparatus 200 determines that the second and fourth speakers 20 and 40 are placed at the left front of the location detecting apparatus 200 according to a result of sensing by the second sensor 221-2, and determines that the first, third, and fifth speakers 10, 30, and 50 are placed at the right front of the location detecting apparatus 200 according to a result of sensing by the fifth sensor 221-5. Next, the controller 230 transmits location information obtained as a result of determining to the electronic apparatus 100.

Accordingly, the controller 140 of the electronic apparatus 100 determines audio output channels of the second and fourth speakers 20 and 40 as a left front output channel, and determines audio output channels of the first, third, and fifth speaker 10, 30, and 50 as a right front output channel, based on the location information received from the location detecting apparatus 200. Next, when audio signals of 5.1 channels are input through the audio input unit 120, the controller 140 transmits am audio signal that is processed to be output through the left front output channel to the second and fourth speakers 20 and 40, and transmits an audio signal that is processed to be output through the right front output channel to the first, third, and fifth speakers 10, 30, and 50. Here, the controller 140 may down-mix the audio signal that is processed to be output through the left front output channel, an audio signal that is output through the center output channel, and an audio signal that is output through the left rear channel, and may transmit the down-mixed audio signals to the second and fourth speakers 20 and 40. Also, the controller 140 down-mixes the audio signal that is processed to be output through the right front output channel, an audio signal that is output through the center output channel, and an audio signal that is output through the right rear channel, and may transmit the down-mixed audio signals to the first, third, and fifth speakers 10, 30, and 50.

Accordingly, the second and fourth speakers 20 and 40 may output a sound that is processed to a signal corresponding to the left front output channel, a sound that is processed into a signal corresponding to the center output channel, and a sound that is processed into a signal corresponding to the left rear channel. Also, the first, third, and fifth speakers 10, 30, and 50 may output a sound that is processed into a signal corresponding to the right front output channel, a sound that is processed in to a signal corresponding to the center output channel, and a sound that is processed into a signal corresponding to the right rear output channel. Here, it is assumed that the user of the electronic apparatus 100 is located at the side of the location detecting apparatus 200. However, this should not be construed as limiting. For example, if the user of the electronic apparatus 100 is located at the side of the electronic apparatus 100, the controller 140 of the electronic apparatus 100 may set the audio output channels of the second and fourth speakers 20 and 40 to a right rear output channel and set the audio output channels of the first, third, and fifth speakers 10, 30, and 50 to a left rear output channel, based on the location information received from the location detecting apparatus 200.

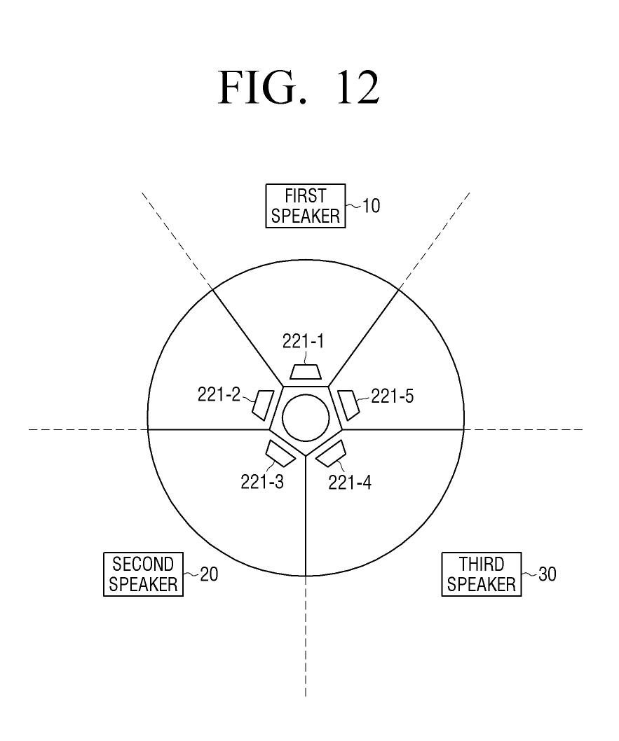

FIG. 12 is an example view for explaining a method for setting an audio output channel of each speaker when a plurality of speakers are respectively placed in three of five regions defined by a location detection apparatus according to an exemplary embodiment.

As shown in FIG. 12, the first, second, and third speakers 10, 20, and 30 may be placed at the center, left rear and right rear of the location detecting apparatus 200. That is, no speaker is placed at the left and right fronts of the location detecting apparatus 200. In this case, only the first, third, and fourth sensors 221-1, 221-3, and 221-4 from among the first to fifth sensors 221-1 to 221-5 may sense audio detection signals that are output through the first, second, and third speakers 10, 20, and 30. That is, the first sensor 221-1 senses an audio detection signal that is output from the first speaker 10, the third sensor 221-3 senses an audio detection signal that is output from the second speaker 20, and the fourth sensor 221-4 senses an audio detection signal that is output from the third speaker 30.

In this case, the controller 230 of the location detecting apparatus 200 determines that the first speaker 10 is placed at the center of the location detecting apparatus 200 according to a result of the sensing by the first sensor 221-1, determines that the second speaker 20 is placed at the left rear of the location detecting apparatus 200 according to a result of the sensing by the third sensor 221-3, and determines that the third speaker 30 is placed at the right rear of the location detecting apparatus 200 according to a result of the sensing by the fourth sensor 221-4. Next, the controller 230 transmits location information of the first to third speakers 10, 20, and 30, determined based on a result of the determining to the electronic apparatus 100.

Accordingly, the controller 140 of the electronic apparatus 100 sets an audio output channel of the first speaker 10 to a center output channel, sets an audio output channel of the second speaker 20 to a left rear output channel, and sets an audio output channel of the third speaker 30 to a right rear output channel, based on the location information received from the location detecting apparatus 200. Next, when audio signals of 5.1 channels are input through the audio input unit 120, the controller 140 transmits an audio signal that is processed to be output through the center output channel to the first speaker and transmits audio signals that are processed to be output through the left and right rear output channels to the second and third speakers 20 and 30, respectively.

Here, the controller 140 down-mixes the audio signal that is processed to be output through the left rear output channel and the audio signal that is processed to be output through the left front channel, and transmits the down-mixed audio signals to the second speakers 20. Also, the controller 140 down-mixes the audio signal that is processed to be output through the right rear output channel and the audio signal that is processed to be output through the right front output channel, and transmits the down-mixed audio signals to the third speaker 30. Accordingly, the first speaker 10 outputs a sound that is processed into a signal corresponding to the center output channel, and the second speaker 20 outputs a sound corresponding to the left rear output channel and a sound corresponding to the left front output channel. The third speaker 30 may output a sound that is processed into a signal corresponding to the right rear output channel and a sound that is processed into a signal corresponding to the right front output channel.

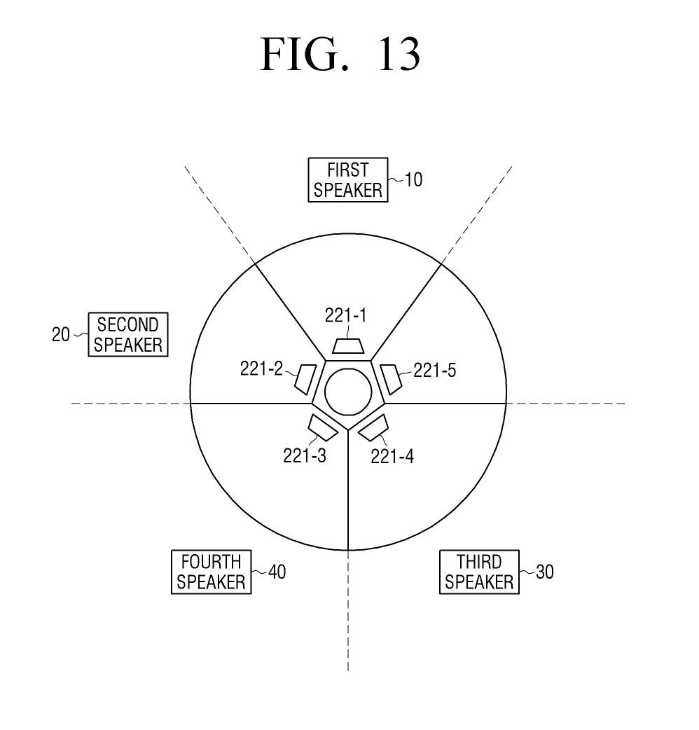

FIG. 13 is an example view for explaining a method for setting an audio output channel of a plurality of speakers that are placed in four of five regions defined by a location detection apparatus according to an exemplary embodiment.

As shown in FIG. 13, the first to fourth speakers 10 to 40 may be placed in regions other than the right front of the location detecting apparatus 200. In this case, the sensors other than the fifth sensor 221-5 from among the first to fifth sensors 221-1 to 221-5 may sense audio detection signals that are output through the first to fourth speakers 10 to 40. In this case, the controller 230 of the location detecting apparatus 200 determines that the first speaker 10 is placed at the center of the location detecting apparatus 200 according to a result of the sensing by the first sensor 221-1, determines that the second speaker 20 is placed at the left front of the location detecting apparatus 200 according to a result of the sensing by the second sensor 221-2, and determines that the third and fourth speakers 30 and 40 are placed at the right and left rears, respectively, according to a result of the sensing by the third and fourth sensors 222-1 and 221-4. Next, the controller 230 transmits location information determined based on a result of the determining to the electronic apparatus 100.

The controller 140 of the electronic apparatus 100 sets an audio output channel of the first speaker 10 to a center output channel and sets an audio output channel of the second speaker 20 to a left front output channel based on the location information received from the location detecting apparatus 200. Also, the controller 140 sets an audio output channel of the third speaker 30 to a right rear output channel and sets an audio output channel of the fourth speaker 40 to a left rear output channel. Next, when audio signals of 5.1 channels are input through the audio input unit 120, the controller 140 transmits an audio signal that is processed to be output through the center output channel to the first speaker 10, transmits an audio signal that is processed to be output through the left front output channel to the second speaker 20, and transmits audio signals that are processed to be output through the right and left rear output channels to the third and fourth speakers 30 and 40, respectively.

The controller 140 down-mixes the audio signal that is processed to be output through the right rear output channel and the audio signal that is processed to be output through the right front output channel, and transmits the down-mixed audio signals to the third speaker 30. Accordingly, the first speaker 10 outputs a sound that is processed into a signal corresponding to the center output channel, the second speaker 20 outputs a sound that is processed into a signal corresponding to the left front output channel, and the fourth speaker 40 outputs a sound that is processed into a signal corresponding to the left rear output channel. The third speaker 30 outputs a sound corresponding to the right front output channel and a sound corresponding to the right rear output channel.

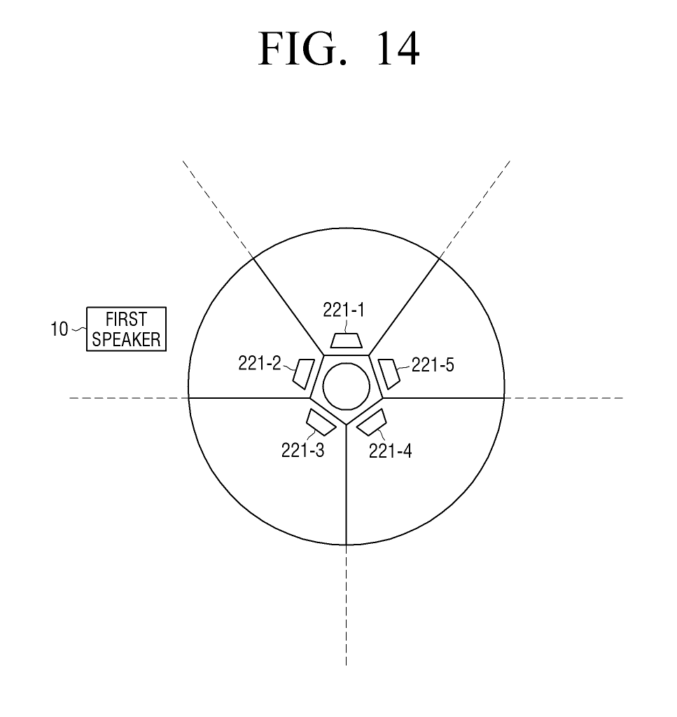

FIG. 14 is an example view for explaining a method for setting an audio output channel of a speaker that is placed in one of five regions defined by a location detection apparatus according to an exemplary embodiment.

As shown in FIG. 14, the first speaker 10 may be placed at the left front of the location detecting apparatus 200. In this case, the second sensor 221-2 from among the first to fifth sensors 221-1 to 221-5 may sense an audio detection signal that is output through the first speaker 10. In this case, the controller 230 of the location detecting apparatus 200 determines that only the first speaker 10 is placed at the left front of the location detecting apparatus 200 and transmits corresponding location information to the electronic apparatus 100. When audio signals of 5.1 channels are input through the audio input unit 120, the controller 140 of the electronic apparatus 100 determines whether the first speaker 10 is able to support a stereo signal. When it is determined that the first speaker 10 is able to support a stereo signal, the controller 140 down-mixes the audio signals of the 5.1 channels which are processed into signals corresponding to the output channels of the audio signals input through the audio input unit 120, and may output the down-mixed audio signals to the first speaker 10. Accordingly, the first speaker 10 may output a down-mixed sound. On the other hand, when it is determined that the first speaker 10 is not able to support a stereo signal, the controller 140 down-mixes the audio signals of the 5.1 channels which are processed into the signals corresponding to the output channels of the audio signals into a predetermined one channel, and may output the audio signals to the first speaker 10. Accordingly, the first speaker 10 may output a down-mixed sound through a single channel.

In the above, configurations of the location detecting apparatus 200 which detects locations of the first to fifth speakers 10 to 50 and a configuration of the electronic apparatus 100 which determines audio output channels of the first to fifth speakers 10 to 50 based on the location information detected by the location detecting apparatus 200 and transmits input audio signals to the first to fifth speaker 10 to 50 based on the determined audio output channels have been described.

Hereinafter, a method for detecting locations of the first to fifth speakers 10 to 50 in the location detecting apparatus 200 and a method for controlling the first to fifth speakers 10 to 50 outputting input audio signals in the electronic apparatus 100 will be explained in detail.

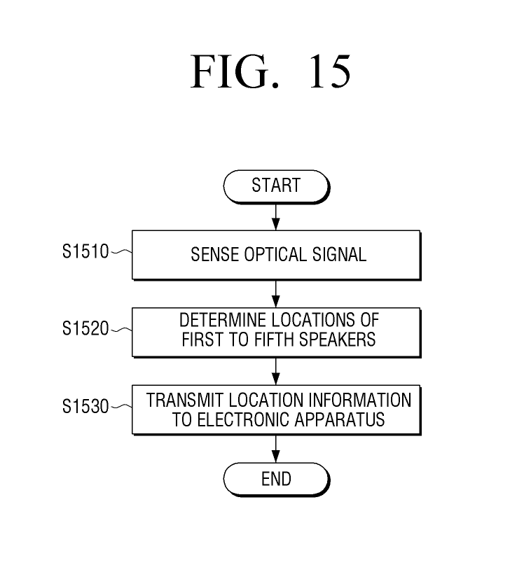

FIG. 15 is a flowchart illustrating a method for detecting locations of a plurality of speakers according to an exemplary embodiment.

As shown in FIG. 15, the location detecting apparatus 200 senses optical signals output from the first to fifth speakers 10 to 50 using a sensor including a plurality of sensors which are placed in different regions (S1510). The optical signals may be IR signals. However, this should not be considered as limiting. The signals output from the first to fifth speakers 10 to 50 may be RF signals that enable bidirectional communications.

When the optical signals of the first to fifth speakers 10 to 50 are sensed as described above, the location detecting apparatus 200 determines locations of the first to fifth speakers 10 to 50 based on the optical signals sensed by the plurality of sensors (S1520). Next, the location detecting apparatus 200 transmits location information of the first to fifth speakers 10 to 50 to the electronic apparatus 100 (S1530). In an exemplary embodiment, the sensor may include a first sensor 221-1 which is placed in, for example, a center direction of the electronic apparatus 100, second and third sensors 221-2 and 221-3 which are placed in, for example, left and right front directions of the electronic apparatus 100, and fourth and fifth sensors 221-4 and 221-5 which are placed in, for example, left and right rear directions of the electronic apparatus 100.

Accordingly, the first sensor 221-1 may sense an optical signal that is output from the first speaker 10 which is placed in the center direction of the electronic apparatus 100, and the second and third sensors 221-2 and 221-3 may sense optical signals that are output from the second and third speakers 20 and 30 which are placed in the left and right front directions of the electronic apparatus 100. Also, the fourth and fifth sensors 221-4 and 221-5 may sense optical signals that are output from fourth and fifth speakers 40 and 50 which are placed in the left and right rear directions of the electronic apparatus 100.

Also, in an exemplary embodiment, the sensor may include partitions which partition the first to fifth sensors 221-1 to 221-5 which are placed in different regions defined by the partitions to sense the optical signals output from the first to fifth speakers 10 to 50. The partitions are used to adjust the optical signals output from the first to fifth speakers 10 to 50 to be output only to the first to fifth sensors 221-1 to 221-5 which are placed in the regions corresponding to the first to fifth speakers 10 to 50. Since the partitions are located between the sensors as described above, the first and fifth sensors 221-1 to 221-5 may sense only the optical signals that are output from the first to fifth speakers 10 to 50 placed corresponding thereto.

Also, the sensor may provide display information indicating when the first sensor 221-1 is placed in the center direction of the electronic apparatus 100. Accordingly, the user may place the first sensor 221-1 to be positioned in the center direction of the electronic apparatus 100 based on the display information.

On the other hand, when the optical signals of the first to fifth speakers 10 to 50 are sensed by the first to fifth sensors, 221-1 to 221-5, the location detecting apparatus 200 may determine locations of the first to fifth speakers 10 to 50. Specifically, the location detecting apparatus 200 may store identification information and placement information of the first to fifth sensors 221-1 to 221-5. Accordingly, when the optical signals output from the first to fifth speakers 10 to 50 are sensed by the first to fifth sensors 221-1 to 221-5, the location detecting apparatus 200 may determine the locations of the first to fifth speakers 10 to 50 based on a result of the sensing by the first to fifth sensors 221-1 to 221-5 and the pre-stored placement information of the first to fifth sensors 221-1 to 221-5.

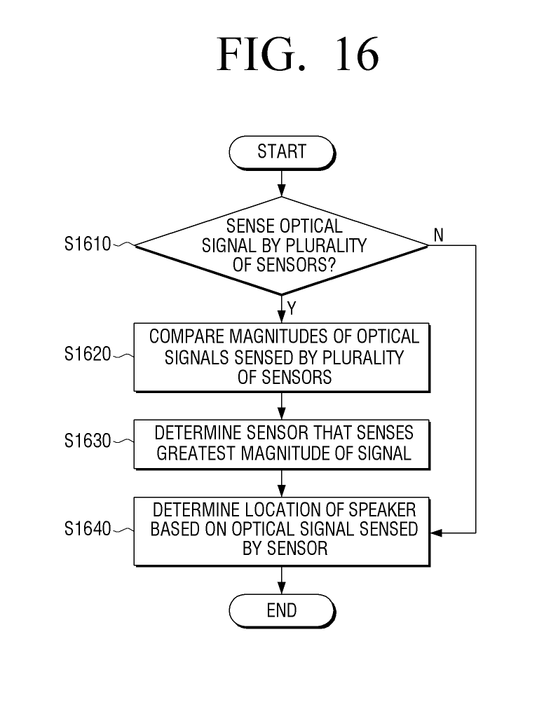

FIG. 16 is a flowchart illustrating a method for determining locations of a plurality of speakers when an optical signal from a speaker is sensed by a plurality of sensors according to an exemplary embodiment.

As shown in FIG. 16, the location detecting apparatus 200 determines whether optical signal are sensed by at least two of the first to fifth sensors 221-1 to 221-5 within a predetermined threshold time (S1610). That is, the location detecting apparatus 200 determines whether an optical signal output from one of the first to fifth speakers 10 to 50 is sensed by at least two of the first to fifth sensors 221-1 to 221-5 within a predetermined threshold time. As a result of the determining, when it is determined that optical signal is sensed by at least two sensors within the predetermined threshold time, the location detecting apparatus 200 compares magnitudes of the optical signals sensed by the at least two sensors (S1620). Next, the location detecting apparatus 200 determines a sensor that senses the greatest magnitude of the optical sensor (S1630). Next, the location detecting apparatus 200 determines a location of the speaker that outputs the optical signal based on a result of the sensing by the sensor that is determined to sense the greatest magnitude of the optical signal in operation S1620 and placement information of that the corresponding sensor (S1640). On the other hand, when it is determined that the optical signal is sensed by one of the first to fifth sensors 221-1 to 221-5 in operation S1610, the location detecting apparatus 200 may determine a location of the speaker that outputs the optical signal based on a result of the sensing by the sensor that detects the optical signal and the placement information of the sensor in operation S1640.

For example, an optical signal may be output from the first speaker 10 from among the first to fifth speakers 10 to 50 and the first and second sensors 221-1 and 221-2 from among the first to fifth sensors 221-1 to 221-5 may sense the optical signal output from the first speaker 10 with a predetermined threshold time. In this case, the location detecting apparatus 200 compares magnitudes of the optical sensors sensed by the first and second sensors 221-1 and 221-2. As a result of the comparing, when it is determined that the magnitude of the optical signal sensed by the first sensor 221-1 is greater than the magnitude of the optical signal sensed by the second sensor 221-2, the location detecting apparatus 200 may determine that the first sensor 221-1 senses the optical signal output from the first speaker 10. Next, the location detecting apparatus 200 may determine a location of the first speaker 10 based on a result of the sensing by the first sensor 221-2 and placement information of the first sensor 221-1.

When the locations of the first to fifth speakers 10 to 50 are determined in this manner, the location detecting apparatus 200 transmits the location information of the first to fifth speakers 10 to 50 to the electronic apparatus 100. Accordingly, the electronic apparatus 100 determines audio output channels of the first to fifth speakers 10 to 50 based on the location information of the first to fifth speakers 10 to 50 received from the location detecting apparatus 200 and outputs the audio signals to the first to fifth speakers 10 to 50 according to the determined audio output channels.

Hereinafter, a method in which an electronic apparatus determines audio output channels of first to fifth speakers 10 to 50 and outputs audio signals to the first to fifth speakers 10 to 50 according to the determined audio output channels according to an exemplary embodiment will be explained.

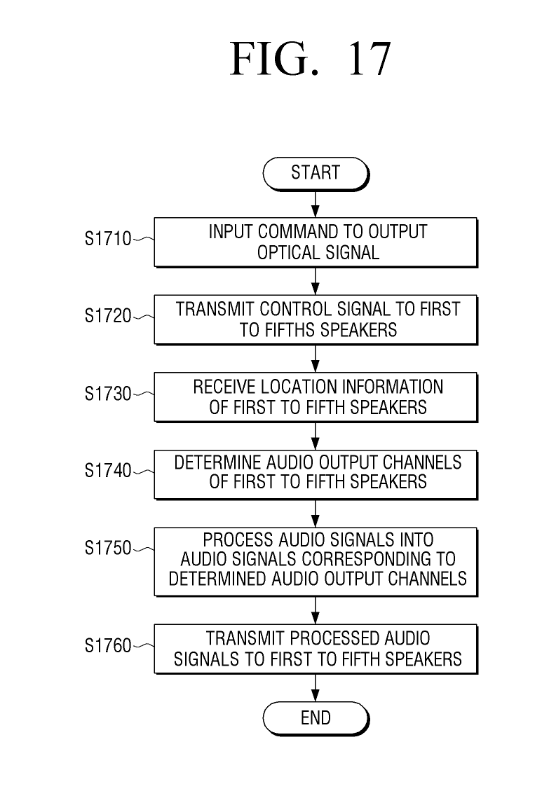

FIG. 17 is a flowchart illustrating a method for setting output channels of a plurality of speakers outputting audio signals according to an exemplary embodiment.

As shown in FIG. 17, when a user command to output an optical signal to first to fifth speakers 10 to 50 is input or a user command to output an optical signal is input from the location detecting apparatus 200 (S1710), the electronic apparatus 100 transmits a control signal to output an optical signal to the first to fifth speakers 10 to 50 (S1720). When location information of the first to fifth speakers 10 to 50 is received from the location detecting apparatus 200 (S1730), the electronic apparatus 100 determines audio output channels of the first to fifth speakers 10 to 50 based on the received location information (51740). Next, the electronic apparatus 100 processes audio signals input from an external source into audio signals corresponding to the determined audio output channels of the first to fifth speakers 10 to 50 (S1750). Next, the electronic apparatus 100 transmits the audio signals that are processed to correspond to the audio output channels to the first to fifth speakers 10 to 50 through the corresponding audio output channels (S1760).

In an exemplary embodiment, when the information of the first to fifth speakers 10 to 50 is received from the location detecting apparatus 200, the electronic apparatus 100 determines a number of region defined by the location detecting apparatus 200 in which the first to fifth speakers 10 to 50 are placed based on the location information, and determines audio output channels of the first to fifth speakers 10 to 50. Specifically, the electronic apparatus 100 may store identification of the first to fifth speakers 10 to 50. Accordingly, when location information including identification information of the first to fifth speakers 10 to 50 is received from the location detecting apparatus 200, the electronic apparatus 100 may determine the number of regions in which the first to fifth speakers 10 to 50 are placed based on the identification information included in the received location information and the pre-stored identification information. Next, the electronic apparatus 100 may determine audio output channels of the first to fifth speakers 10 to 50 according to the number of regions defined by the location detecting apparatus 200 in which the first to fifth speakers 10 to 50 are placed.

According to an exemplary embodiment, it may be determined that audio signals input from an external apparatus are 5.1 channels and the first to fifth speakers 10 to 50 are placed in five regions. In this case, the electronic apparatus 100 may determine audio output channels of the first to fifth speaker 10 to 50 as 5.1 channels. When the audio output channels of the first to fifth speakers 10 to 50 are determined, the electronic apparatus 100 processes the audio signals input from the external source into audio signals corresponding to the determined audio output channels. Accordingly, the electronic apparatus 100 may transmit the processed audio signals to the first to fifth speakers 10 to 50 through the audio output channels corresponding to the audio signals. On the other hand, when it is determined that channels of audio signals input from an external source are 5.1 channels and the number of regions in which the first to fifth speakers 10 to 50 are placed is less than 5, the electronic apparatus 100 may determine audio output channels corresponding to the number of regions in which the first to fifth speakers 10 to 50 are placed. That is, if the determined number of audio output channels is less than the number of channels of the input audio signals, the electronic apparatus 100 may down-mix the input audio signals based on the determined number of audio output channels. For example, when it is determined that channels of audio signals are 5.1 channels and three audio output channels are determined for the first to fifth speakers 10 to 50, the controller 140 down-mixes the audio signals of the 5.1 channels into audio signals of 3 channels and outputs the audio signals through the first to fifth speakers 10 to 50.

In an exemplary embodiment, in operation S1760, the electronic apparatus 100 may delay transmitting audio signals to the first to fifth speaker 10 to 50 based on distance information of the first to fifth speakers 10 to 50. Hereinafter, a method for obtaining distance information of the first to fifth speakers 10 to 50 in the electronic apparatus 100 according to an exemplary embodiment will be explained.

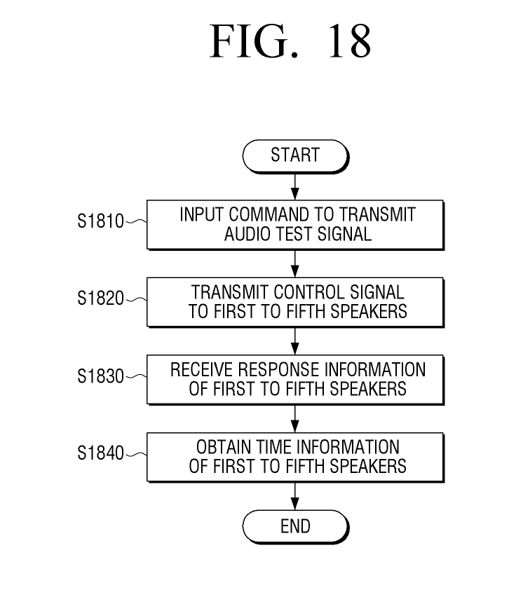

FIG. 18 is a flowchart illustrating a method for obtaining distance information of a plurality of speakers according to an exemplary embodiment.

As shown in FIG. 18, the electronic apparatus 100 receives a command to output an audio test signal from, for example, the user or the location detecting apparatus 200 (S1810). When such a command is input, the electronic apparatus 100 transmits a control signal to output an audio test signal to the first to fifth speakers 10 to 50 (S1820). Here, for example, the electronic apparatus 100 may transmit the control signal to the first to fifth speaker 10 to 50 in sequence. That is, the electronic apparatus 100 first transmits the control signal to output the audio test signal to, for example, the first speaker 10 first and then transmits the control signal to the other speakers in sequence. Accordingly, the first to fifth speakers 10 to 50 output audio test signals in sequence, and, when the audio test signals output from the first to fifth speakers 10 to 50 are input, the location detecting apparatus 200 transmits response information including identification information of the first and fifth speakers 10 to 50 to the electronic apparatus 100. When the response information of the first to fifth speaker 10 to 50 is received from the location detecting apparatus 200 (S1830), the electronic apparatus 100 obtains respective time information of the first to fifth speaker 10 to 50 on a time interval from when the control signal to output the audio test signal is transmitted to the first to fifth speakers 10 to 50 to when the response information of the first to fifth speakers 10 to 50 is received (S1840). Accordingly, the electronic apparatus 100 may control a timing of transmitting audio signals to the first to fifth speaker 10 to 50 based on the time information of the first to fifth speakers 10 to 50.

For example, the first speaker 10 may be set to a center output channel, the second and third speakers 20 and 30 may be set to left and right front output channels, and the fourth and fifth speaker 40 and 50 may be set to left and right rear output channels. When it is determined that the fifth speaker 50 is farthest from the electronic apparatus 100 based on the distance information of the first to fifth speakers 10 to 50, the electronic apparatus 100 may delay transmitting audio signals to the first to fourth speakers 10 to 40 based on a time required for the audio signal processed into a signal corresponding to the right rear output channel to arrive at the fifth speaker 50. Accordingly, a delay may not occur in sounds output through the first to fifth speakers 10 to 50.

In the above, various aspects of exemplary embodiments have been described.

According to the exemplary embodiments described above, the location detecting apparatus may detect the locations of the plurality of speakers through the plurality of sensors which are placed in different regions, and the electronic apparatus may set the audio output channels of the plurality of speakers based on the location information of the plurality of speakers detected by the location detecting apparatus.

The foregoing exemplary embodiments and advantages are merely exemplary and are not to be construed as limiting the inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A location detecting apparatus for detecting a location of a speaker, the location detecting apparatus comprising:
a communication unit configured to communicate with a plurality of speakers;
a plurality of sensors configured to sense optical signals respectively output from the plurality of speakers; and
a controller configured to determine locations of the plurality of speakers according to a result of the sensing by the plurality of sensors and control the communication unit to transmit the determined location information of the plurality of speakers to an external apparatus, wherein the external apparatus sets audio output channels corresponding to the plurality of speakers based on the determined location information of the plurality of speakers.

2. The location detecting apparatus as claimed in claim 1, wherein the plurality of sensors comprise:
a first sensor which is placed in a center direction of the location detecting apparatus;
second and third sensors which are placed in left and right front directions of the location detecting apparatus, respectively; and
fourth and fifth sensors which are placed in left and right rear directions of the location detecting apparatus, respectively.

3. The location detecting apparatus as claimed in claim 2, further comprising:
a partition provided between the first to fifth sensors such that the first to fifth sensors sense the optical signals output from the plurality of speakers in corresponding directions thereof; and
a display configured to indicate when the first sensor is at a center direction of the location detecting apparatus.

4. The location detecting apparatus as claimed in claim 2, wherein, when an optical signal is sensed by at least two of the plurality of sensors within a predetermined threshold time, the controller compares magnitudes of the optical signal sensed by the at least two of the plurality of sensors and determines a location of a speaker which outputs the optical signal based on a location of the sensor which senses a greatest magnitude of the optical signal.

5. The location detecting apparatus as claimed in claim 1, wherein the optical signal is an infrared rays (IR) signal.

6. An electronic apparatus comprising:
a communication unit configured to communicate with a location detecting apparatus for detecting location information of a speaker; and
an audio receiver configured to receive audio signals;
an audio processor configured to process the input audio signals; and
a controller configured to determine audio output channels corresponding to a plurality of speakers based on location information of the plurality of speakers which is received from the location detecting apparatus through the communication unit, control the audio processor to process the input audio signals into audio signals corresponding to the determined audio output channels, and control the communication unit to transmit the processed audio signals to the plurality of speakers.

7. The electronic apparatus as claimed in claim 6, wherein the controller determines a number of regions defined by the location detecting apparatus in which the plurality of speakers are placed based on the location information of the plurality of speakers and determine the audio output channels of the plurality of speakers further based on the determined number of regions.

8. The electronic apparatus as claimed in claim 7, wherein, when channels of the input audio signals are 5.1 channels and the number of regions in which the plurality of speakers are placed is five, the controller determines the audio output channels of the plurality of speakers as 5.1 channels.

9. The electronic apparatus as claimed in claim 8, wherein, when a number of the determined audio output channels is less than a number of the channels of the input audio signals, the controller controls the audio processor to down-mix the input audio signals based on the determined audio output channels.

10. The electronic apparatus as claimed in claim 6, further comprising an input unit which receive a user command,
wherein, when the user command is input, the controller transmits a control signal to output an optical signal to the plurality of speakers, and
wherein the location detecting apparatus detects the location information of the plurality of speakers using the optical signal output from the plurality of speakers.

11. A speaker output channel setting system comprising:
a plurality of speakers configured to output optical signals;
a location detecting apparatus configured to detect the output optical signals by using a plurality of sensors which are placed in different directions and detect location information of the plurality of speakers based on sensing by the plurality of sensors; and
an electronic apparatus configured to determine audio output channels of the plurality of speakers based on the location information of the plurality of speakers detected by the location detecting apparatus, process audio signals input from an external source into audio signals corresponding to the determined audio output channels, and transmit the processed audio signals to the plurality of speakers.

12. The speaker output channel setting system as claimed in claim 11, wherein, in response to a user command, the electronic apparatus transmits a control signal to output an optical signal to the plurality of speakers.

13. The speaker output channel setting system as claimed in claim 11, wherein the electronic apparatus determines a number of regions defined by the location detecting apparatus in which the plurality of speakers are placed based on the location information of the plurality of speakers detected by the location detecting apparatus and determines the audio output channels of the plurality of speakers further based on the determined number of regions.

14. The speaker output channel setting system as claimed in claim 13, wherein, when a number of the determined audio output channels is less than a number of channels of the audio signals input from the external source, the electronic apparatus down-mixes the input audio signals based on the determined audio output channels.

15. The speaker output channel setting system as claimed in claim 11, wherein the location detecting apparatus further comprises a microphone which receive an audio test signal output through the plurality of speakers, and, when the audio test signal is input from the plurality of speakers through the microphone, the location detecting apparatus transmits response information to the electronic apparatus.

16. The speaker output channel setting system as claimed in claim 15, wherein the electronic apparatus transmits a control signal to output the audio test signal to the plurality of speakers according to a user command, obtains distance information of the plurality of speakers based on time information on a time interval from when the control signal is transmitted to the plurality of speakers to when the response information is received from the location detecting apparatus, and controls a timing of transmitting audio signals to the plurality of speakers based on the obtained distance information.

17. A method for detecting a location of a speaker in a location detecting apparatus, the method comprising:
sensing, by a plurality of sensors, optical signals respectively output from a plurality of speakers;
determining locations of the plurality of speakers based on the optical signals sensed by the plurality of sensors; and
transmitting the location information of the plurality of speakers to an external apparatus, wherein the external apparatus sets audio output channels corresponding to the plurality of speakers based on the determined location information of the plurality of speakers.

18. The method as claimed in claim 17, wherein the plurality of sensors comprise:
a first sensor which is placed in a center direction of the location detecting apparatus;
second and third sensors which are placed in left and right front directions of the location detecting apparatus, respectively; and
fourth and fifth sensors which are placed in left and right rear directions of the location detecting apparatus, respectively.

19. The method as claimed in claim 18, further comprising:
providing a partition between the plurality of sensors; and
sensing the optical signals respectively output from the plurality of speakers in corresponding directions of the plurality of sensors.

20. The method as claimed in claim 18, further comprising:
providing display information indicating when the first sensor is at a center direction of the electronic apparatus.

21. The method as claimed in claim 18, wherein the determining the locations comprises:
determining whether an optical signal is sensed by at least two of the plurality of sensors within a predetermined threshold time;
when the optical signal is sensed by the at least two sensors as a result of the determining, comparing magnitudes of the sensed optical signal sensed by the at least two of the plurality of sensors; and
determining a location of a speaker which outputs the optical signal based on a location of the sensor which senses a greatest magnitude of the optical signal.

22. The method as claimed in claim 17, wherein the optical signal is an IR signal.

23. A method for setting an output channel of a speaker in an electronic apparatus, the method comprising:
receiving location information of a plurality of speakers from a location detecting apparatus;
determining audio output channels corresponding to the plurality of speakers based on the location information of the plurality of speakers;
processing input audio signals into audio signals corresponding to the determined audio output channels; and
transmitting the processed audio signals to the plurality of speakers through the audio output channels corresponding to the plurality of speakers.

24. The method as claimed in claim 23, wherein the determining the audio output channels comprises determining a number of regions defined by the location detecting apparatus in which the plurality of speakers are placed based on the location information of the plurality of speakers and determining the audio output channels of the plurality of speakers further based on the determined number of regions.

25. The method as claimed in claim 24, wherein the determining the audio output channels comprises:
when channels of the input audio signals are 5.1 channels and the determined number of regions in which the plurality of speakers are placed is five, determining the audio output channels of the plurality of speakers as 5.1 channels.

26. The method as claimed in claim 25, wherein the processing comprises, when a number of the determined audio output channels is less than a number of the channels of the input audio signals, down-mixing the input audio signals based on the determined audio output channels.

27. The method as claimed in claim 23, further comprising:
receiving a user command;
when the user command is input, transmitting a control signal to output an optical signal to the plurality of speakers; and
obtaining, by the location detecting apparatus, the location information of the plurality of speakers using the optical signal output from the plurality of speakers.

28. A system for providing multi-channel audio signals, comprising:
a plurality of speakers configured to output the multi-channel audio signals; and
a multi-channel audio generator configured to obtain location information of the plurality of speakers, determine audio output channels of the multi-channel audio signals based on the location information of the plurality of speakers, and transmit the multi-channel audio signals corresponding to the determined audio output channels to the plurality of speakers.

29. The system as claimed in claim 28, wherein the multi-channel audio signals have a multi-channel audio format determined according to a location distribution of the plurality of speakers.

30. The system as claimed in claim 29, wherein the multi-channel audio generator processes an input audio signal according to the determined multi-channel audio format.

31. The system as claimed in claim 29, wherein the location distribution of the plurality of speakers is determined based on defining different regions according to a multi-channel audio format of an input audio signal from an external source.

32. The system as claimed in claim 28, wherein the multi-channel audio generator down-mixes an input audio signal when the determined audio output channels have a lower number of channels than channels of the input audio signal.
